(19) United States
(12) Patent Application Publication
(10) Pub. No.: US 2025/0301464 A1
(43) Pub. Date: Sep. 25, 2025

(54) UPLINK TRANSMISSION WITH ORTHOGONAL COVER CODES

(71) Applicant: QUALCOMM Incorporated, San Diego, CA (US)

(72) Inventors: Jae Ho RYU, San Diego, CA (US); Alberto RICO ALVARINO, San Diego, CA (US); Xiao Feng WANG, San Diego, CA (US); Hari SANKAR, San Diego, CA (US)

(21) Appl. No.: 18/609,796

(22) Filed: Mar. 19, 2024

(51) Int. Cl. H04W 72/1268; H04L 5/00; H04W 72/23

(52) U.S. Cl. CPC H04W 72/1268; H04L 5/0007; H04W 72/23

(57) ABSTRACT

Methods, systems, and devices for wireless communications are described. A UE may transmit one or more uplink messages according to an orthogonal cover code (OCC) and an OCC scheme indicated by a network entity. The UE may receive control signaling scheduling one or more uplink messages for transmission. The control signaling may also indicate one or more OCC parameters for the one or more uplink messages. The UE may receive second control signaling that indicates that an OCC scheme for uplink messages is enabled. The control signaling may indicate a row within a time domain resource allocation (TDRA) table or a row within an OCC table. In either case, the row may correspond to the one or more OCC parameters. The UE may transmit the one or more uplink messages using an OCC in accordance with the one or more OCC parameters, the OCC scheme, or both.

### FIELD OF TECHNOLOGY

The following relates to wireless communications, including uplink transmission with orthogonal cover codes.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support uplink transmission with orthogonal cover codes (OCCs). For example, the described techniques provide for a UE to transmit one or more uplink messages according to an OCC and an OCC scheme indicated by a network entity via control signaling. For example, the UE may receive, from the network entity, control signaling (e.g., downlink control information) that schedules one or more uplink messages and indicates one or more OCC parameters such as an OCC index or a spreading factor. In some cases, the UE may receive second control signaling (e.g., radio resource control signaling) that indicates that an OCC scheme for uplink messages is enabled. In some examples, the control signaling may indicate a row within a time domain resource allocation (TDRA) table, the row corresponding to the one or more OCC parameters. Additionally or alternatively, the control signaling may indicate a row within an OCC table, the row corresponding to the one or more OCC parameters. The UE may thus transmit, to the network entity, the one or more uplink messages using an OCC in accordance with the one or more OCC parameters, the OCC scheme, or both, based on the control signaling, the second control signaling, or both.

A method for wireless communications by a UE is described. The method may include receiving control signaling that schedules one or more uplink messages for transmission by the UE, where the control signaling that schedules the one or more uplink messages also indicates one or more OCC parameters for the one or more uplink messages, and transmitting, based on the control signaling, the one or more uplink messages using an OCC in accordance with the one or more OCC parameters.

A UE for wireless communications is described. The UE may include one or more memories storing processor executable code, and one or more processors coupled with the one or more memories. The one or more processors may individually or collectively be operable to execute the code to cause the UE to receive control signaling that schedules one or more uplink messages for transmission by the UE, where the control signaling that schedules the one or more uplink messages also indicates one or more OCC parameters for the one or more uplink messages, and transmit, based on the control signaling, the one or more uplink messages using an OCC in accordance with the one or more OCC parameters.

Another UE for wireless communications is described. The UE may include means for receiving control signaling that schedules one or more uplink messages for transmission by the UE, where the control signaling that schedules the one or more uplink messages also indicates one or more OCC parameters for the one or more uplink messages, and means for transmitting, based on the control signaling, the one or more uplink messages using an OCC in accordance with the one or more OCC parameters.

A non-transitory computer-readable medium storing code for wireless communications is described. The code may include instructions executable by one or more processors to receive control signaling that schedules one or more uplink messages for transmission by the UE, where the control signaling that schedules the one or more uplink messages also indicates one or more OCC parameters for the one or more uplink messages, and transmit, based on the control signaling, the one or more uplink messages using an OCC in accordance with the one or more OCC parameters.

Some examples of the method, UEs, and non-transitory computer-readable medium described herein may further include operations, features, means, or instructions for receiving second control signaling that indicates that an OCC scheme for uplink messages may be enabled, where transmitting the one or more uplink messages may be further in accordance with the OCC scheme.

In some examples of the method, UEs, and non-transitory computer-readable medium described herein, to indicate that the OCC scheme may be enabled, the second control signaling indicates one OCC scheme from among a set of OCC schemes, the one indicated OCC scheme including the OCC scheme that may be enabled.

In some examples of the method, UEs, and non-transitory computer-readable medium described herein, the control signaling includes a downlink control information message and the second control signaling includes radio resource control signaling.

In some examples of the method, UEs, and non-transitory computer-readable medium described herein, based on indicating the one or more OCC parameters, the control signaling implicitly indicates that an OCC scheme may be enabled.

Some examples of the method, UEs, and non-transitory computer-readable medium described herein may further include operations, features, means, or instructions for receiving radio resource control signaling that indicates a spreading factor for the OCC.

In some examples of the method, UEs, and non-transitory computer-readable medium described herein, to indicate the one or more OCC parameters, the control signaling indicates a row within a TDRA table, the row corresponding to the one or more OCC parameters.

In some examples of the method, UEs, and non-transitory computer-readable medium described herein, the one or more OCC parameters corresponding to the row within the TDRA table include a spreading factor for the OCC, an OCC index corresponding to the OCC, or both.

In some examples of the method, UEs, and non-transitory computer-readable medium described herein, to indicate the one or more OCC parameters, the control signaling further indicates that the TDRA table may be a first TDRA table from among a set of TDRA tables that includes the first TDRA table and a second TDRA table, the first TDRA table including OCC parameters and the second TDRA table devoid of OCC parameters.

In some examples of the method, UEs, and non-transitory computer-readable medium described herein, to indicate the one or more OCC parameters, the control signaling indicates a row within an OCC table, the row including the one or more OCC parameters.

Some examples of the method, UEs, and non-transitory computer-readable medium described herein may further include operations, features, means, or instructions for receiving, within the control signaling, an indication of a row within a TDRA table, where transmitting the one or more uplink messages may be further in accordance with one or more parameters corresponding to the row within the TDRA table, and where the OCC table may be separate from the TDRA table.

In some examples of the method, UEs, and non-transitory computer-readable medium described herein, the one or more OCC parameters corresponding to the row within the OCC table include a spreading factor for the OCC, an OCC index corresponding to the OCC, or both.

In some examples of the method, UEs, and non-transitory computer-readable medium described herein, transmitting the one or more uplink messages may include operations, features, means, or instructions for transmitting the one or more uplink messages via a physical uplink shared channel.

A method for wireless communications by a network entity is described. The method may include outputting control signaling that schedules one or more uplink messages for transmission by a UE, where the control signaling that schedules the one or more uplink messages also indicates one or more OCC parameters for the one or more uplink messages, and obtaining, based on the control signaling, the one or more uplink messages based on an OCC that is in accordance with the one or more OCC parameters.

A network entity for wireless communications is described. The network entity may include one or more memories storing processor executable code, and one or more processors coupled with the one or more memories. The one or more processors may individually or collectively be operable to execute the code to cause the network entity to output control signaling that schedules one or more uplink messages for transmission by a UE, where the control signaling that schedules the one or more uplink messages also indicates one or more OCC parameters for the one or more uplink messages, and obtain, based on the control signaling, the one or more uplink messages based on an OCC that is in accordance with the one or more OCC parameters.

Another network entity for wireless communications is described. The network entity may include means for outputting control signaling that schedules one or more uplink messages for transmission by a UE, where the control signaling that schedules the one or more uplink messages also indicates one or more OCC parameters for the one or more uplink messages, and means for obtaining, based on the control signaling, the one or more uplink messages based on an OCC that is in accordance with the one or more OCC parameters.

A non-transitory computer-readable medium storing code for wireless communications is described. The code may include instructions executable by one or more processors to output control signaling that schedules one or more uplink messages for transmission by a UE, where the control signaling that schedules the one or more uplink messages also indicates one or more OCC parameters for the one or more uplink messages, and obtain, based on the control signaling, the one or more uplink messages based on an OCC that is in accordance with the one or more OCC parameters.

In some examples of the method, network entities, and non-transitory computer-readable medium described herein, the control signaling schedules the one or more uplink messages for transmission by the UE via a first set of time and frequency resources and the method, apparatuses, and non-transitory computer-readable medium may include further operations, features, means, or instructions for outputting other control signaling that schedules one or more other uplink messages for transmission by a second UE via a second set of time and frequency resources that at least partially overlaps in time and frequency with the first set of time and frequency resources, where the other control signaling that schedules the one or more other uplink messages also indicates one or more second OCC parameters for the one or more other uplink messages, and where at least one of the one or more second OCC parameters for the one or more other uplink messages for transmission by the second UE may be different from at least one of the one or more OCC parameters for the one or more uplink messages for transmission by the UE and obtaining, based on the other control signaling, the one or more other uplink messages based on a second OCC that may be different from the OCC and may be in accordance with the one or more second OCC parameters.

Some examples of the method, network entities, and non-transitory computer-readable medium described herein may further include operations, features, means, or instructions for outputting second control signaling that indicates that an OCC scheme for uplink messages may be enabled, where the one or more uplink messages may be further in accordance with the OCC scheme.

In some examples of the method, network entities, and non-transitory computer-readable medium described herein, to indicate that the OCC scheme may be enabled, the second control signaling indicates one OCC scheme from among a set of OCC schemes, the one indicated OCC scheme including the OCC scheme that may be enabled.

In some examples of the method, network entities, and non-transitory computer-readable medium described herein, the control signaling includes a downlink control information message and the second control signaling includes radio resource control signaling.

In some examples of the method, network entities, and non-transitory computer-readable medium described herein, based on indicating the one or more OCC parameters, the control signaling implicitly indicates that an OCC scheme may be enabled.

Some examples of the method, network entities, and non-transitory computer-readable medium described herein may further include operations, features, means, or instructions for outputting radio resource control signaling that indicates a spreading factor for the OCC.

In some examples of the method, network entities, and non-transitory computer-readable medium described herein, to indicate the one or more OCC parameters, the control signaling indicates a row within a TDRA table, the row corresponding to the one or more OCC parameters.

In some examples of the method, network entities, and non-transitory computer-readable medium described herein, the one or more OCC parameters corresponding to the row within the TDRA table include a spreading factor for the OCC, an OCC index corresponding to the OCC, or both.

In some examples of the method, network entities, and non-transitory computer-readable medium described herein, to indicate the one or more OCC parameters, the control signaling further indicates that the TDRA table may be a first TDRA table from among a set of TDRA tables that includes the first TDRA table and a second TDRA table, the first TDRA table including OCC parameters and the second TDRA table devoid of OCC parameters.

In some examples of the method, network entities, and non-transitory computer-readable medium described herein, to indicate the one or more OCC parameters, the control signaling indicates a row within an OCC table, the row including the one or more OCC parameters.

Some examples of the method, network entities, and non-transitory computer-readable medium described herein may further include operations, features, means, or instructions for outputting, within the control signaling, an indication of a row within a TDRA table, where obtaining the one or more uplink messages may be further in accordance with one or more parameters corresponding to the row within the TDRA table, and where the OCC table may be separate from the TDRA table.

In some examples of the method, network entities, and non-transitory computer-readable medium described herein, the one or more OCC parameters corresponding to the row within the OCC table include a spreading factor for the OCC, an OCC index corresponding to the OCC, or both.

In some examples of the method, network entities, and non-transitory computer-readable medium described herein, obtaining the one or more uplink messages may include operations, features, means, or instructions for obtaining the one or more uplink messages via a physical uplink shared channel.

### BRIEF DESCRIPTION OF THE DRAWINGS

FIG. 1 shows an example of a wireless communications system that supports uplink transmission with orthogonal cover codes (OCCs) in accordance with one or more aspects of the present disclosure.

FIG. 2 shows an example of a wireless communications system that supports uplink transmission with OCCs in accordance with one or more aspects of the present disclosure.

FIGS. 3A-3C show examples of OCC procedures that support uplink transmission with OCCs in accordance with one or more aspects of the present disclosure.

FIGS. 4A-4C show examples of tables that support uplink transmission with OCCs in accordance with one or more aspects of the present disclosure.

FIG. 5 shows an example of a process flow that supports uplink transmission with OCCs in accordance with one or more aspects of the present disclosure.

FIGS. 6 and 7 show block diagrams of devices that support uplink transmission with OCCs in accordance with one or more aspects of the present disclosure.

FIG. 8 shows a block diagram of a communications manager that supports uplink transmission with OCCs in accordance with one or more aspects of the present disclosure.

FIG. 9 shows a diagram of a system including a device that supports uplink transmission with OCCs in accordance with one or more aspects of the present disclosure.

FIGS. 10 and 11 show block diagrams of devices that support uplink transmission with OCCs in accordance with one or more aspects of the present disclosure.

FIG. 12 shows a block diagram of a communications manager that supports uplink transmission with OCCs in accordance with one or more aspects of the present disclosure.

FIG. 13 shows a diagram of a system including a device that supports uplink transmission with OCCs in accordance with one or more aspects of the present disclosure.

FIGS. 14 through 18 show flowcharts illustrating methods that support uplink transmission with OCCs in accordance with one or more aspects of the present disclosure.

### DETAILED DESCRIPTION

Orthogonal cover codes (OCCs) may allow for multiple wireless devices to transmit via overlapping time and frequency resources by using different respective OCCs. For example, a first user equipment (UE) may transmit one or more first messages that are encoded based on a first OCC, and a second UE may transmit one or more second messages that are encoded based on a second OCC. A receiving device (e.g., base station) may be able to differentiate (e.g., successfully decode) the one or more first messages and the one or more second messages, even if they are received via the same or overlapping time and frequency resources, based on the different OCCs. The use of OCCs for wireless transmissions thus may enhance network throughput or capacity, among other potential benefits. Techniques described herein support the indication of OCC-related parameters to one or more wireless devices (e.g. UEs), such that the one or more wireless devices may subsequently perform OCC-based transmissions.

For example, a UE may transmit one or more uplink messages according to an OCC and an OCC scheme that are indicated by a network entity via control signaling. For example, the UE may receive, from the network entity, control signaling (e.g., DCI signaling) that schedules a set of one or more uplink messages. The control signaling may further indicate a set of one or more OCC parameters such as an OCC index (e.g., an index corresponding to a particular OCC) an OCC spreading factor, or both. In some cases, the UE may receive second control signaling (e.g., radio resource control signaling) that indicates that an OCC scheme for uplink messages is enabled. In some examples, the control signaling may indicate a row within a time domain resource allocation (TDRA) table, the row corresponding to the set of one or more OCC parameters. Additionally or alternatively, the control signaling may indicate a row within an OCC table, the row corresponding to the set of one or more OCC parameters. The UE may thus transmit, to the network entity, the one or more uplink messages using an OCC in accordance with the set of one or more OCC parameters, the OCC scheme, or both, based on the control signaling, the second control signaling, or both.

Aspects of the disclosure are initially described in the context of wireless communications systems. Aspects of the disclosure are then described in the context of OCC schemes, TRDA tables, an OCC table, and a process flow. Aspects of the disclosure are further illustrated by and described with reference to apparatus diagrams, system diagrams, and flowcharts that relate to uplink transmission with OCCs.

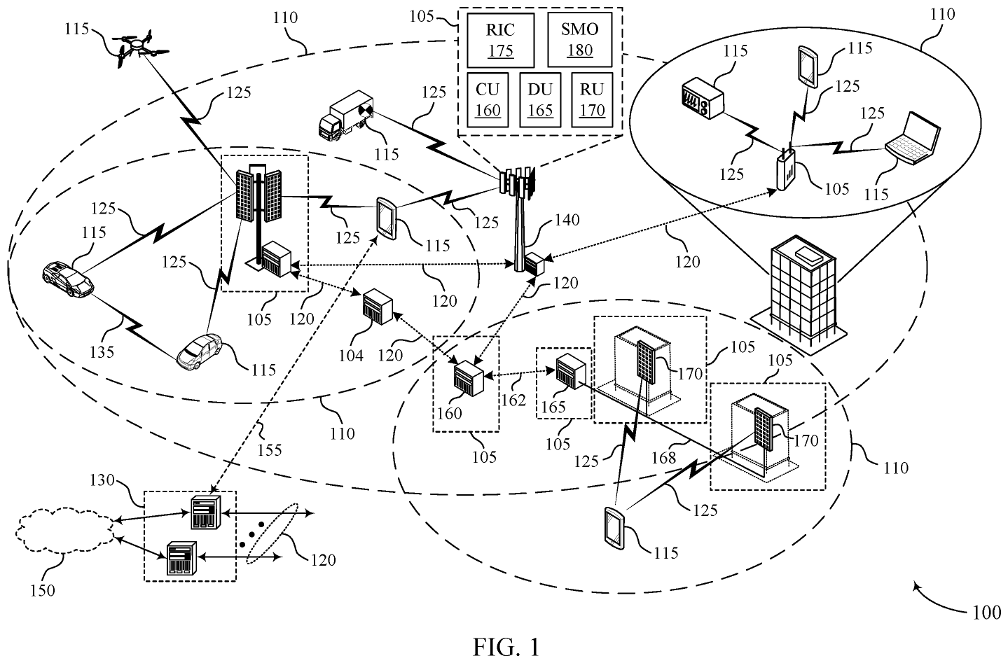

FIG. 1 shows an example of a wireless communications system 100 that supports uplink transmission with OCCs in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may support DFT-S-OFDM physical uplink shared channel (PUSCH) enhancements via OCCs. For example, the wireless communications system 100 may support such DFT-S-OFDM while considering one or more communication factors (e.g., realistic impairments such as Doppler, time variation, phase distortion, and so on). In some cases, one or more devices of the wireless communications system 100 (e.g., a UE 115 and a network entity 105) may perform signaling to support such enhancements. The wireless communications system 100 may support wireless communications using OCCs across OFDM symbols, across slots, within a single OFDM symbol, or any combination thereof.

A UE 115 may perform one or more uplink (e.g., PUSCH) transmissions with OCC, allowing for uplink transmission with repetition while refraining from sacrificing resource efficiency due to repetition. In some cases, one or more UEs 115 may perform uplink transmissions with OCC on a set of time-frequency resources (e.g., with minimal performance degradation). In some examples, each UE 115 of the one or more UEs 115 may achieve a coverage enhancement based on performing repetitions. In some implementations, the wireless communications system 100 may support different types of OCC configurations. An OCC configuration may be referred to as an OCC scheme. For example, the wireless communications system 100 may support OCC schemes such as frequency-domain OCC (FD-OCC), a frequency-domain comb scheme (e.g., FD-comb), a time domain OCC (TD-OCC) with respect to symbols (e.g., TD-OCC-symbol), a time domain OCC with respect to slots (e.g., TD-OCC-slot), or any combination thereof.

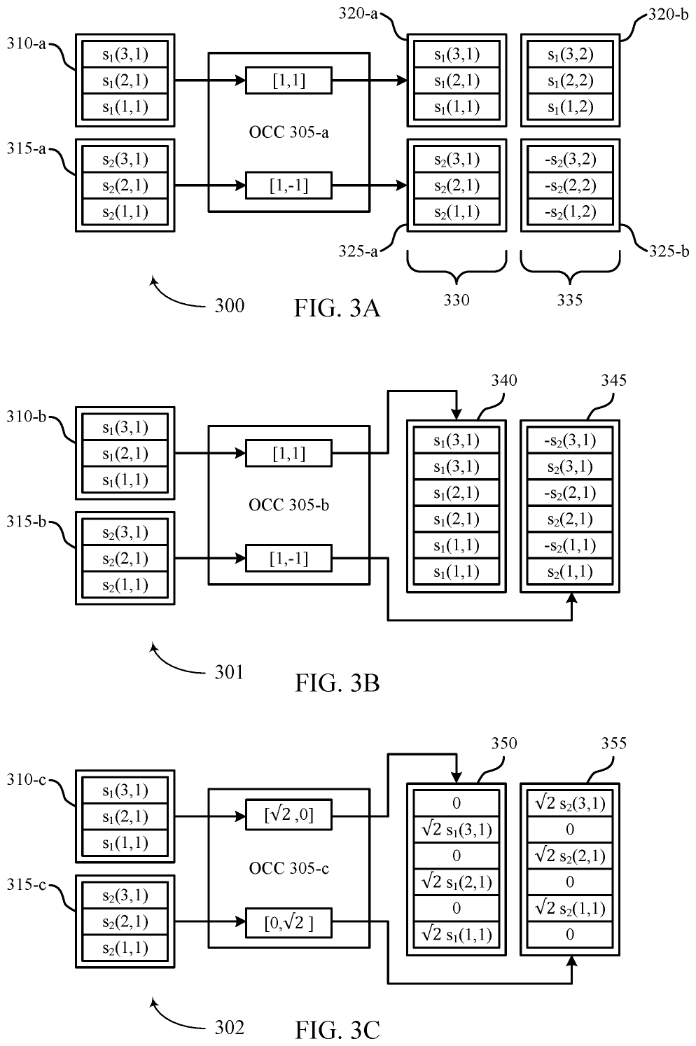

For example, a first UE 115 and a second UE 115 may transmit respective resource elements according to a time domain OCC with a spreading factor of 2. The first UE 115 may transmit, according to the time domain OCC scheme, two repetitions of a first tone via respective adjacent symbols (e.g., the two repetitions may not be inverted). Similarly, the second UE 115 may transmit, according to the time domain OCC scheme, a first repetition of a second tone via a first symbol. The second UE 115 may transmit a second repetition of the second tone, via a second symbol that is adjacent to the first symbol and is inverted compared to the first repetition. In some cases, the described repetitions transmitted by each UE 115 may be referred to as spread entities. Thus, the spread entities transmitted by each UE may be orthogonal to each other. Further examples of OCC schemes are described with reference to FIGS. 3A-3C.

In some wireless communications systems, a UE may transmit one or more uplink messages according to an OCC scheme, allowing the UE to transmit repetitions of the one or more uplink messages without sacrificing resource efficiency due to repetition. Thus, a mechanism to indicate an OCC scheme and OCC parameters for uplink transmissions is desirable. Further, solutions that allow a UE to dynamically switch between OCC transmitting modes (e.g., transmitting according to an OCC scheme and transmitting without regard to an OCC scheme) are desirable.

The wireless communications system 100 may support a UE 115 that may transmit one or more uplink messages according to an OCC scheme and OCC parameters indicated by a network entity 105 via control signaling. For example, the UE 115 may receive, from the network entity 105, control signaling that schedules one or more uplink messages for transmission by the UE 115. The control signaling that schedules the one or more uplink messages may also indicate one or more OCC parameters for the one or more uplink messages. In some cases, the UE 115 may receive second control signaling that indicates that an OCC scheme for uplink messages is enabled. In some examples, the control signaling may indicate a row within a TDRA table or a row within an OCC table. In either case, the row may correspond to the one or more OCC parameters. The UE 115 may transmit, to the network entity 105, the one or more uplink messages using an OCC in accordance with the one or more OCC parameters, the OCC scheme, or both, based on the control signaling, the second control signaling, or both. Thus, the wireless communications system 100 may support a mechanism to receive an indication of an OCC scheme and OCC parameters for uplink transmissions and may support dynamic switching between OCC transmission modes.

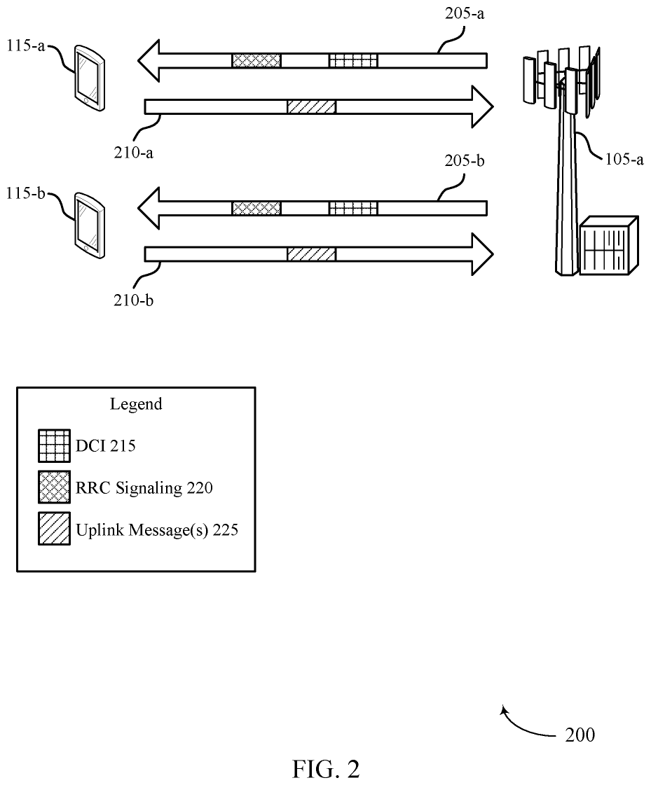

FIG. 2 shows an example of a wireless communications system 200 that supports uplink transmission with OCCs in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a and a UE 115-b) and one or more network entities 105 (e.g., a network entity 105-a), which may be examples of the corresponding devices as described herein. The one or more UEs 115 may receive downlink signaling from the network entity 105-a via one or more downlink connections 205 (e.g., the UE 115-a via a downlink connection 205-a and the UE 115-a via a downlink connection 205-b). Similarly, the one or more UEs 115 may transmit uplink signaling to the network entity 105-a via one or more uplink connections 210 (e.g., the UE 115-a via a downlink connection 210-a and the UE 115-b via a downlink connection 210-b). In the following description of the wireless communications system 200, although some operations are described to be performed by the UE 115-a or the UE 115-b individually, the described operations may also be performed by any of the UE 115-a, the UE 115-b, another UE 115, or a group of UEs 115.

In some cases, the wireless communications system 200 may support a single OCC scheme or may support multiple OCC schemes (e.g., both FD-OCC and TD-OCC). In some examples, the wireless communications system 200 may support a configuration of one or more OCC parameters for a particular UE 115. For example, the wireless communications system 200 may support dynamic indication of OCC parameters via downlink control information (DCI) indication.

In some implementations, the UE 115-a may receive a DCI 215 from the network entity 105-a. The DCI 215 may schedule one or more uplink messages 225. Additionally, the DCI 215 may indicate one or more OCC parameters for the one or more uplink messages 225.

In some cases, the UE 115-a may receive RRC signaling 220 (or other types of downlink control signaling) from the network entity 105-a. Although RRC signaling is discussed herein, another type of control signaling may be used. In some examples, the RRC signaling 220 may be specific to the UE 115-a or another UE 115 (e.g., UE specific RRC signaling). If the wireless communications system 200 supports multiple OCC schemes for uplink transmissions (e.g., PUSCH transmissions) with OCC, the RRC signaling 220 may indicate an OCC scheme. For example, the RRC signaling 220 may indicate one OCC scheme among a set of OCC schemes (e.g., FD-OCC, FD-comb, TD-OCC-symbol, TD-OCC-slot) described further with reference to FIGS. 3A-3C. In some cases, “uplink transmission with OCC” may refer to a process that includes transmitting the one or more uplink messages 225 (e.g., PUSCH transmissions) according to an OCC scheme, according to one or more OCC parameters, using a particular OCC, or any combination thereof.

If the wireless communications system 200 supports a single OCC scheme, the UE 115-a may determine that an uplink transmission with OCC is enabled based on one or more factors. For example, the UE 115-a may receive a first RRC configuration that explicitly enables or disables the uplink transmission with OCC. Additionally or alternatively, the UE 115-a may receive a second RRC configuration that implicitly enables the uplink transmission with OCC. That is, the UE 115-a may determine that the uplink transmission with OCC is enabled based on a presence of an RRC configuration that is related to (e.g., associated with) uplink transmission with OCC. For example, the RRC configuration may include one or more OCC parameters (such as a spreading factor for an OCC, which may alternatively be referred to as an OCC factor), a TDRA table that includes OCC parameters, an indication identifying one or more rows of the TDRA table, an OCC indication table, an indication of one or more rows of the OCC table, or any combination thereof.

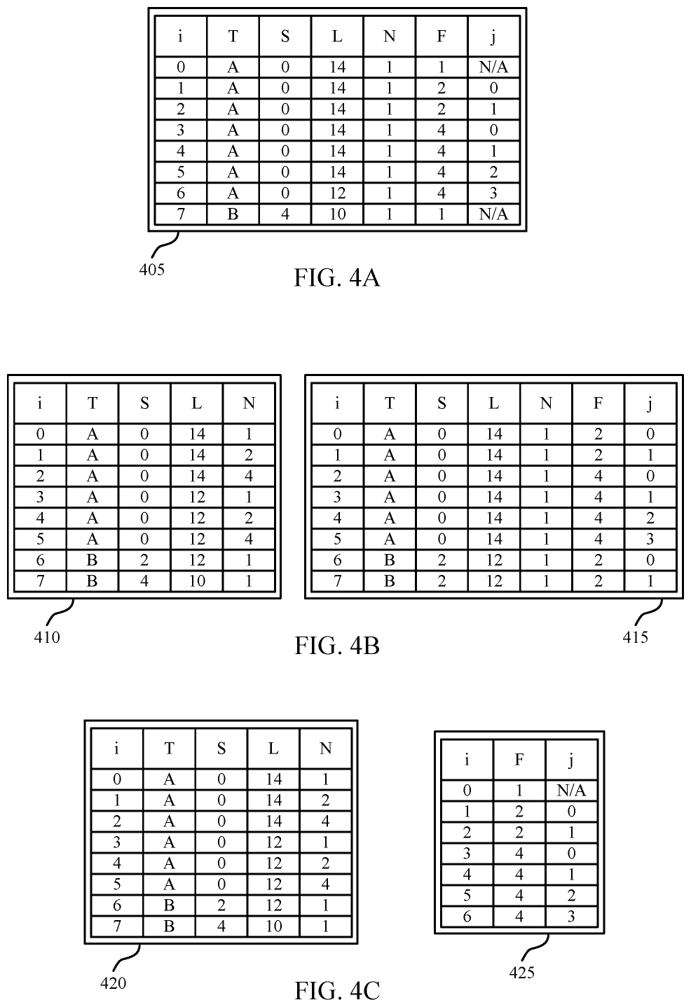

The UE 115-a may receive one or more messages that indicate one or more OCC parameters associated with uplink transmissions with OCC. In some cases, the UE 115-a may receive an RRC configuration (e.g., in the RRC signaling 220 or in other control signaling) that configures the one or more OCC parameters. For example, the RRC configuration may configure a spreading factor for an OCC. In some examples, the UE 115-a and the UE 115-b may support dynamic OCC transmission (e.g., switching between different OCC parameters for multiple uplink transmissions). For example, the UE 115-a may receive, or may be configured with, one or more TDRA tables, one or more OCC tables, or any combination thereof. Examples of TDRA tables and OCC tables are described further with reference to FIGS. 4A-4C.

In some implementations, the UE 115-a may receive, in the DCI 215, in other control signaling, or both, an indication of one or more rows (e.g., of the TDRA table, the OCC table, or both) that correspond to the one or more OCC parameters that the UE 115-a is to use for transmitting the one or more uplink messages 225. For example, the UE may receive the DCI 215 (e.g., an uplink scheduling DCI) that includes a TDRA field. The TDRA field of the DCI 215 may indicate a row of a TDRA table which indicates an uplink transmission with OCC. The indicated row of the TDRA table may include one or more OCC parameters including an OCC factor (e.g., a spreading factor), an OCC index, or both. In some examples, if a row includes an OCC factor having a value ‘1’, the row may indicate a non-OCC uplink transmission (e.g., that the UE is to transmit the one or more uplink messages 225 without respect to an OCC scheme). FIG. 4A provides further details regarding the TDRA table that includes the one or more OCC parameters.

In some cases, the DCI 215 may include an OCC flag (e.g., a one-bit indication associated with OCCs) and the TDRA field. The network entity 105-a may configure a set of two or more separate TDRA tables. For example, the set of two or more separate TDRA tables may include a first TDRA table corresponding to uplink transmission without OCC (e.g., transmitting uplink messages without respect to an OCC, or non-OCC uplink transmissions) and a second TDRA table corresponding to uplink transmission with OCC. In some cases, if the OCC flag has a first value (e.g., ‘0’), the UE 115-a may determine that the TDRA field indicates a row of the first TDRA table. If the OCC flag has a second value (e.g., ‘1’), the UE 115-a may determine that the TDRA field indicates a row of the second TDRA table (e.g., that an OCC scheme is to be used). The first TDRA table may include TDRA parameters such as a mapping type, a start symbol, a length, a number of repetitions, or any combination thereof. The second TDRA table may also include the TDRA parameters, and additionally or alternatively, may include one or more OCC parameters including an OCC factor, an OCC index, or both. In some examples, each row of the second TDRA table may correspond to a respective OCC scheme. Thus, each OCC factor of the one or more OCC parameters may have a value greater than one (e.g., since an OCC spreading factor of one would indicate non-use of an OCC scheme).

In some implementations, the DCI 215 may include an OCC field, a TDRA field, or both. For example, the OCC field may include an indication of an OCC, an OCC factor, an OCC index, or any combination thereof. In some cases, the network entity 105-a may configure an OCC table for uplink transmission with OCC. The network entity 105-a may thus transmit the DCI 215 that indicates a row of the OCC table (e.g., an OCC configuration table) corresponding to an OCC scheme that the UE 115-a is to use to transmit the one or more uplink messages 225. The OCC table may include one or more OCC parameters, such as an OCC factor, an OCC index, or both. In some cases, at least one row of the OCC table may indicate an OCC factor having a value of one (e.g., to indicate an uplink transmission without OCC). In some examples, the UE 115-a may determine an OCC scheme, factor, index, or any combination thereof, based on a row of the OCC table indicated in the DCI 215, and may separately determine a TDRA based on row of a TDRA table indicated in the DCI 215.

In some cases, the UE 115-a and the UE 115-b may receive, from the network entity 105-a, respective DCIs 215. For example, the UE 115-a may receive a first DCI 215 indicating a first OCC scheme, a first OCC factor, and a first OCC index. The UE 115-b may receive a second DCI 215 indicating the first OCC scheme, the first OCC factor, and a second OCC index that is different from the first OCC index. Thus, the UE 115-a and the UE 115-b may transmit respective uplink messages 225 according to a same OCC scheme while avoiding sacrificing resource efficiency.

The following descriptions of FIGS. 3A-3C illustrate further examples of OCC procedures and OCC schemes (e.g., time domain OCCs, frequency domain OCCs, sub-physical resource block (sub-PRB) OCCs, and so on) that may be applied for uplink transmission at one or more UEs 115. In each of FIGS. 3A-3C, the UE 115-a and the UE 115-b may transmit a set of data tones via a set of time and frequency resources. For example, the data tones are represented by rectangles, with time and frequency resources (e.g., resource elements) corresponding to each data tone in the form sᵢ(k, t), where i indicates the particular UE (e.g., ‘1’ for UE 115-a and ‘2’ for UE 115-b), where k indicates a frequency resource, and where t indicates a time resource.

FIG. 3A shows an example of a time domain OCC procedure 300 that supports uplink transmission with OCCs in accordance with one or more aspects of the present disclosure. The time domain OCC procedure 300 includes an OCC scheme 305-a (e.g., a time domain OCC). The OCC scheme 305-a may include two or more OCCs, represented by respective vectors (e.g., [1, 1] or [1, −1]). Each OCC of the two or more OCCs may correspond to a respective index. For example, OCC index ‘0’ may indicate a first OCC within the OCC scheme 305-a (e.g., [1, 1]) and OCC index ‘1’ may indicate a second OCC within the OCC scheme 305-a (e.g., [1, −1]). Although the OCC scheme 305-a is illustrated to correspond to a spreading factor of 2 for simplicity, other spreading factors may also be used for a given OCC scheme. For example, if the OCC scheme 305-a corresponds to a spreading factor of 4, the OCC scheme 305-a may include four OCCs, each corresponding to a respective index of a set of four indexes (e.g., ‘0’, ‘1’, ‘2’, and ‘3’), and each represented by a respective 4-dimensional vector (e.g., [1, 1, 1, 1], [1, −1, 1, −1], [1, 1, −1, −1], and [1, −1, −1, 1]). Thus, two or more UEs 115 (e.g., up to a quantity of UEs 115 equal to an indicated spreading factor), may apply similar techniques, as described below, to transmit messages using OCCs according to a spreading factor of two or more.

A UE 115-a may generate a set of input data tones 310-a and may expand the set of input data tones 310-a using a first OCC of the OCC scheme 305-a (e.g., a code [1, 1]) to obtain sets of output data tones 320. The UE 115-a may thus transmit the sets of output data tones 320. Similarly, a UE 115-b may generate a set of input data tones 315-a and may expand the set of input data tones 315-a using a second OCC of the OCC scheme 305-a (e.g., a code [1, −1]) to obtain sets of output data tones 325. The UE 115-b may thus transmit the sets of output data tones 325.

In accordance with the OCC scheme 305-a (e.g., a time domain OCC scheme), the UE 115-a may transmit the sets of output data tones 320 based on repeating the set of input data tones 310-a. For example, the UE 115-a may transmit a first set of output data tones 320-a during a first period 330 (e.g., a first OFDM symbol period) and may transmit a second set of output data tones 320-b during a second period 335 (e.g., a second OFDM symbol period). In some cases, the first period 330 and the second period 335 may be respective examples of slot periods. Thus, the OCC scheme 305-a may support time-domain OCCs that are with respect to symbols or with respect to slots. In some examples, the first set of output data tones 320-a and the second set of output data tones 320-b may be respective copies of the set of input data tones 310-a (e.g., in accordance with the code [1, 1]).

Similarly, the UE 115-b may transmit the sets of output data tones 325 based on repeating the set of input data tones 315-a. For example, the UE 115-b may transmit a first set of output data tones 325-a during the first period 330 and may transmit a second set of output data tones 325-b during the second period 335. The first set of output data tones 325-a may be a copy of the set of input data tones 315-a, and the second set of output data tones 325-b may be inverted compared to the first set of output data tones 325-a (e.g., in accordance with the code [1, −1]). For example, if the UE 115-b transmits the first set of output data tones 325-a via time-frequency resources s₂(3,1), s2(2,1), and s2(1,1), the UE 115-b may transmit the second set of output data tones 325-b via time-frequency resources −s₂(3,2), −s₂(2,2), and −s₂(1,2). Thus, the UE 115-a and the UE 115-b may apply the OCC scheme 305-a to transmit repetitions across symbols (e.g., data tones across one OFDM symbol may be expanded across two or more OFDM symbols according to the spreading factor).

FIG. 3B shows an example of a frequency domain OCC procedure 301 that supports uplink transmission with OCCs in accordance with one or more aspects of the present disclosure. The frequency domain OCC procedure 301 includes an OCC scheme 305-b (e.g., a frequency domain OCC). The OCC scheme 305-b may include two or more OCCs, represented by respective vectors (e.g., [1, 1] or [1, −1]). Each OCC of the two or more OCCs may correspond to a respective index. For example, OCC index ‘0’ may indicate a first OCC within the OCC scheme 305-b (e.g., [1, 1]) and OCC index ‘1’ may indicate a second OCC within the OCC scheme 305-b (e.g., [1, −1]). Although the OCC scheme 305-b is illustrated to correspond to a spreading factor of 2 for simplicity, other spreading factors may also be used for a given OCC scheme. For example, in accordance with a spreading factor of 4, the OCC scheme 305-b may include four OCCs, each corresponding to a respective index of a set of four indexes (e.g., ‘0’, ‘1’, ‘2’, and ‘3’), and each represented by a respective 4-dimensional vector (e.g., [1, 1, 1, 1], [1, −1, 1, −1], [1, 1, −1, −1], and [1, −1, −1, 1]). Thus, two or more UEs 115 may apply similar techniques, as described below, to transmit messages using OCCs according to a spreading factor of two or more.

A UE 115-a may generate a set of input data tones 310-b and may expand the set of input data tones 310-b using a first OCC of the OCC scheme 305-b (e.g., a code [1, 1]) to obtain a set of output data tones 340. The UE 115-a may thus transmit the set of output data tones 340. Similarly, a UE 115-b may generate a set of input data tones 315-b and may expand the set of input data tones 315-b using a second OCC of the OCC scheme 305-b (e.g., a code [1, −1]) to obtain a set of output data tones 345. The UE 115-b may thus transmit the set of output data tones 345.

In accordance with the OCC scheme 305-b (e.g., the frequency domain OCC scheme), the UE 115-a may transmit the set of output data tones 340 based on repeating the set of input data tones 310-b in the frequency domain. For example, for a spreading factor of 2 as illustrated, the set of output data tones 340 may include two repetitions of each input data tone of the set of input data tones 310-b. Each output data tone of the set of output data tones 340 may be a copy (or repetition) of a respective input data tone (e.g., not inverted, in accordance with the OCC [1, 1]). Similarly, the UE 115-b may transmit the set of output data tones 345 based on repeating the set of input data tones 315-b in the frequency domain. Each output data tone of the set of output data tones 345 may be a copy or an inverted copy of a respective input data tone. In some cases (e.g., for a spreading factor of 2), each non-inverted output data tone of the set of output data tones 345 may be interposed between two respective inverted output data tones (e.g., in accordance with the OCC [1, −1]). For example, if the UE 115-b transmits the set of input data tones 315-b via time-frequency resources s₂(3,1), s₂(2,1), and s₂(1,1), the UE 115-b may transmit the set of output data tones 345 via time-frequency resources −s₂(3,1), s₂(3,1), −s₂(2,1), s₂(2,1), −s₂(1,1), and s₂(1,1).

In some other cases, (e.g., for a spreading factor of 4, 8, and so on), a UE 115 may transmit non-inverted data tones and inverted data tones in a pattern across a frequency domain in accordance with an indicated OCC. For example, for a spreading factor of 4, the UE 115 may transmit four repetitions of each input data tone, non-inverted or inverted, in accordance with an indicated OCC [1, 1, 1, 1], [1, −1, 1, −1], [1, 1, −1, −1], or [1, −1, −1, 1]. Thus, two or more UEs 115 may apply the OCC scheme 305-b to transmit repetitions across multiple tones within the frequency domain. That is, data tones across one subcarrier in the frequency domain may be expanded across two or more subcarriers, and in a same symbol (e.g., OFDM symbol), according to the spreading factor and in accordance with the OCC scheme 305-b.

FIG. 3C shows an example of a sub-PRB OCC procedure 302 that supports uplink transmission with OCCs in accordance with one or more aspects of the present disclosure. In some cases, the sub-PRB OCC procedure 302 may be referred to as a frequency domain “comb” OCC procedure. The sub-PRB OCC procedure 302 includes an OCC scheme 305-c (e.g., a sub-PRB OCC or a frequency domain “comb” OCC). The OCC scheme 305-c may include two or more OCCs, represented by respective vectors (e.g., [\sqrt{2}, 0] or [0, \sqrt{2}]). Each OCC of the two or more OCCs may correspond to a respective index. For example, OCC index ‘0’ may indicate a first OCC within the OCC scheme 305-c (e.g., [\sqrt{2}, 0]) and OCC index ‘1’ may indicate a second OCC within the OCC scheme 305-c (e.g., [0, \sqrt{2}]). Although the OCC scheme 305-c is illustrated with a spreading factor of 2 for simplicity, other spreading factors may also be used for a given OCC scheme. For example, in accordance with a spreading factor of 4, the OCC scheme 305-c may include four OCCs, each corresponding to a respective index of a set of four indexes (e.g., ‘0’, ‘1’, ‘2’, and ‘3’), and each represented by a respective 4-dimensional vector (e.g., [\sqrt{4}, 0, 0, 0], [0, \sqrt{4}, 0, 0], [0, 0, \sqrt{4}, 0], [0, 0, 0, \sqrt{4}]). Thus, two or more UEs 115 may apply similar techniques, as described below, to transmit messages using OCCs according to a spreading factor of two or more.

A UE 115-a may generate a set of input data tones 310-c and may expand the set of input data tones 310-c using a first OCC of the OCC scheme 305-c (e.g., a code [\sqrt{2}, 0]) to obtain a set of output data tones 350. The UE 115-a may thus transmit the set of output data tones 350. Similarly, a UE 115-b may generate a set of input data tones 315-c and may expand the set of input data tones 315-c using a second OCC of the OCC scheme 305-c (e.g., a code [0, \sqrt{2}]) to obtain a set of output data tones 355. The UE 115-b may thus transmit the set of output data tones 355.

In accordance with the OCC scheme 305-c (e.g., the sub-PRB OCC scheme), the UE 115-a may transmit the set of output data tones 350 based on ordering the set of input data tones 310-c in the frequency domain according to a first pattern. For example, for a spreading factor of 2 as illustrated, the set of output data tones 350 may include a power-boosted data tone corresponding to each input data tone of the set of input data tones 310-c and a set of empty data tones (e.g., having 0 allocated time-frequency resources, or corresponding to empty subcarriers). That is, the UE 115-a may transmit each power-boosted data tone of the set of output data tones 350 according to a power boost (e.g., an increase in power) that is based on a square-root of the spreading factor (e.g., multiplied by \sqrt{2} for spreading factor 2). Similarly, the UE 115-b may transmit the set of output data tones 355 based on ordering the set of input data tones 315-c in the frequency domain according to a second pattern. The set of output data tones 355 may include a power-boosted data tone of each input data tone of the set of input data tones 315-c (e.g., the power may be increased according to the square-root of the spreading factor) and a set of empty data tones.

In some cases, according to the first pattern, each power-boosted data tone of the set of output data tones 350 may be interposed between a set of respective empty data tones in the frequency domain (e.g., in accordance with the OCC [\sqrt{2}, 0]). According to the second pattern, each power-boosted data tone of the set of output data tones 355 similarly may be interposed between a set of respective empty data tones in the frequency domain (e.g., in accordance with the OCC [0, \sqrt{2}]). The second pattern may include empty data tones in one or more subcarriers that correspond to power-boosted subcarriers in the first pattern (e.g., where the first pattern includes power-boosted data tones), and vice versa. For example, if the UE 115-a transmits the set of output data tones 350 via time-frequency resources in the order 0, \sqrt{2}s₁(3,1), 0, \sqrt{2}s₁(2,1), 0, and \sqrt{2}s₁(1,1), the UE 115-b may transmit the set of output data tones 355 via time-frequency resources in the order \sqrt{2}s₂(3,1), 0, \sqrt{2}s₂(2,1), 0, \sqrt{2}s₂(1,1), and 0. Thus, data tones may be arranged in a “comb” within a PRB.

In some other cases, (e.g., for a spreading factor of 4, 8, and so on), a UE 115 may arrange output data tones as empty and power-boosted data tones in a pattern across a frequency domain in accordance with an indicated OCC. For example, for a spreading factor of 4, the UE 115 may transmit a power-boosted data tone with a power boost of \sqrt{4}=2, and may refrain from transmitting data tones in three subcarriers (e.g., that include empty data tones) in accordance with an indicated OCC [2, 0, 0, 0], [0, 2, 0, 0], [0, 0, 2, 0], [0, 0, 0, 2]. Thus, two or more UEs 115 may apply the OCC scheme 305-c to transmit repetitions with increased power on respective subcarriers within the frequency domain. That is, data tones across one subcarrier in the frequency domain may be expanded in a same symbol (e.g., OFDM symbol), such that each UE may transmit a respective data tone with increased power according to the spreading factor and based on the OCC scheme 305-c.

FIG. 4A shows an example of a TDRA table 405 that supports uplink transmission with OCCs in accordance with one or more aspects of the present disclosure. The TDRA table 405 may include one or more TDRA parameters such as a TDRA index i, a mapping type T, a start symbol S, a length L (e.g., a length of symbols in the time domain), a quantity of repetitions N, or any combination thereof. The TDRA table 405 may also include one or more OCC parameters, such as an OCC factor F, an OCC index j, or both. As described with reference to FIG. 2, a UE 115 may receive an indication of a row of the TDRA table 405. The UE 115 may determine, based on the indication of the row, an OCC to use for uplink transmission based on an OCC factor F and an OCC index j within the indicated row. Thus, the UE 115 may transmit one or more uplink messages (e.g., data tones) according to the OCC, as described with reference to FIGS. 3A-3C. If the UE 115 is to transmit the one or more uplink messages without OCC, the indicated row may include an OCC factor of 1.

In some implementations, a network entity 105 may indicate a respective row of the TDRA table 405 to each UE 115 of a set of UEs 115. Each row of the TDRA table 405 may be referred to by a respective TDRA index i. For example, row 1 indicates a mapping type T of type ‘A’, a start symbol S of ‘0’, a length L of ‘14’, a number of repetitions N of 1, an OCC factor F of 2, and an OCC index j of 0. In some cases, the network entity 105 may indicate a set of OCCs to a group of four UEs 115 according to an OCC scheme corresponding to a spreading factor of 4. In such cases, the network entity 105 may transmit an indication of row 3 to a first UE 115, an indication of row 4 to a second UE 115, an indication of row 5 to a third UE 115, and an indication of row 6 to a fourth UE 115. Each UE 115 of the group of four UEs 115 may also determine a TDRA according to the TDRA parameters of each respective row. Thus, the group of four UEs 115 may transmit uplink messages according to a same OCC scheme, using respective (and different) OCCs that correspond to respective OCC indexes j of each indicated row.

FIG. 4B shows an example of a set of tables, including a first TDRA table 410 and a second TDRA table 415, that supports uplink transmission with OCCs in accordance with one or more aspects of the present disclosure. The first TDRA table 410 may include one or more TDRA parameters such as a TDRA index i, a mapping type T, a start symbol S, a length L, a quantity of repetitions N, or any combination thereof. The second TDRA table 415 may include the one or more TDRA parameters, and may also include one or more OCC parameters, such as an OCC factor F, an OCC index j, or both. Each OCC factor F of the second TDRA table 415 may have a value greater than one.

As described with reference to FIG. 2, a UE 115 may receive an OCC flag (e.g., a one-bit indication). For example, if the OCC flag has a value of ‘0’, the UE 115 may determine that an indicated row corresponds to the first TDRA table 410. If the OCC flag has a value of ‘1’, the UE 115 may determine that the indicated row corresponds to the second TDRA table 415. In some cases, the UE 115 may receive an indication of a row (e.g., the indicated row) of the first TDRA table 410 or the second TDRA table 415 based on the OCC flag. The UE 115 may determine, based on the indication of the row, an OCC to use for uplink transmission based on an OCC factor F and an OCC index j within the indicated row. Thus, the UE 115 may transmit one or more uplink messages (e.g., data tones) according to the OCC, as described with reference to FIGS. 3A-3C. If the UE 115 is to transmit the one or more uplink messages without OCC, the OCC flag may indicate that the UE 115 is to identify a row within the first TDRA table 410 (e.g., the UE 115 may determine that OCC is disabled for one or more scheduled uplink messages based on an OCC flag value of ‘0’). The UE 115 may thus determine a TDRA according to the indicated row of the first TDRA table 410 for non-OCC-based uplink messages.

In some implementations, a network entity 105 may indicate a respective row of the first TDRA table 410 or the second TDRA table 415 to each UE 115 of a set of UEs 115. Each row of the first TDRA table 410 and the second TDRA table 415 may be referred to by a respective TDRA index i. For example, row 1 of the second TDRA table 415 indicates a mapping type T of type ‘A’, a start symbol S of ‘0’, a length L of ‘14’, a number of repetitions N of 1, an OCC factor F of 2, and an OCC index j of 1. In some cases, the network entity 105 may indicate a set of OCCs to a group of four UEs 115 according to an OCC scheme corresponding to a spreading factor of 4. In such cases, the network entity 105 may transmit, to each UE 115 of the group of four UEs 115, an OCC flag that indicates the second TDRA table 415 (e.g., the TDRA table that includes OCC parameters). The network entity 105 may also transmit an indication of row 2 to a first UE 115, an indication of row 3 to a second UE 115, an indication of row 4 to a third UE 115, and an indication of row 5 to a fourth UE 115. Each UE 115 of the group of four UEs 115 may also determine a TDRA according to the TDRA parameters of each respective row. Thus, the group of four UEs 115 may transmit uplink messages according to a same OCC scheme, using respective (e.g., different) OCCs that correspond to respective OCC indexes j of each indicated row of the second TDRA table 415.

FIG. 4C shows an example of a set of tables, including a TDRA table 420 and an OCC table 425, that supports uplink transmission with OCCs in accordance with one or more aspects of the present disclosure. The TDRA table 420 may include one or more TDRA parameters such as a TDRA index i, a mapping type T, a start symbol S, a length L, a quantity of repetitions N, or any combination thereof. The OCC table 425 may include one or more OCC parameters, such as an OCC table index i, an OCC factor F, an OCC index j, or any combination thereof. At least one row of the OCC table 425 may include an OCC factor of ‘1’ (e.g., to indicate uplink transmission without OCC).

As described with reference to FIG. 2, a UE 115 may receive a first indication of a row of the TDRA table 420, a second indication of a row of the OCC table 425, or both. The UE 115 may determine a TDRA to use for uplink transmission according to the indicated row of the TDRA table 420 for uplink transmission. In some cases, the UE 115 may determine an OCC to use for uplink transmission based on an OCC factor F and an OCC index j within the indicated row of the OCC table 425. Thus, the UE 115 may transmit one or more uplink messages according to the OCC, as described with reference to FIGS. 3A-3C. If the UE 115 is to transmit the one or more uplink messages without OCC, the second indication may indicate a row of the OCC table 425 that corresponds to an OCC factor F of 1. In any case, the UE 115 may transmit the one or more uplink messages according to a TDRA corresponding to the row of the TDRA table 420 of the first indication. Thus, the UE 115 may determine the TDRA separately from the OCC that the UE 115 may use for uplink transmission.

In some implementations, a network entity 105 may indicate a respective row of the OCC table 425 to each UE 115 of a set of UEs 115. Each row of the OCC table 425 may be referred to by a respective OCC table index i. For example, row 1 of the OCC table 425 indicates an OCC factor F of 2 and an OCC index j of 0. In some cases, the network entity 105 may indicate a set of OCCs to a group of four UEs 115 according to an OCC scheme corresponding to a spreading factor of 4. In such cases, the network entity 105 may transmit an indication of row 3 to a first UE 115, an indication of row 4 to a second UE 115, an indication of row 5 to a third UE 115, and an indication of row 6 to a fourth UE 115. Thus, the group of four UEs 115 may transmit uplink messages according to a same OCC scheme, using respective OCCs that correspond to respective OCC indexes j of each indicated row of the OCC table 425.

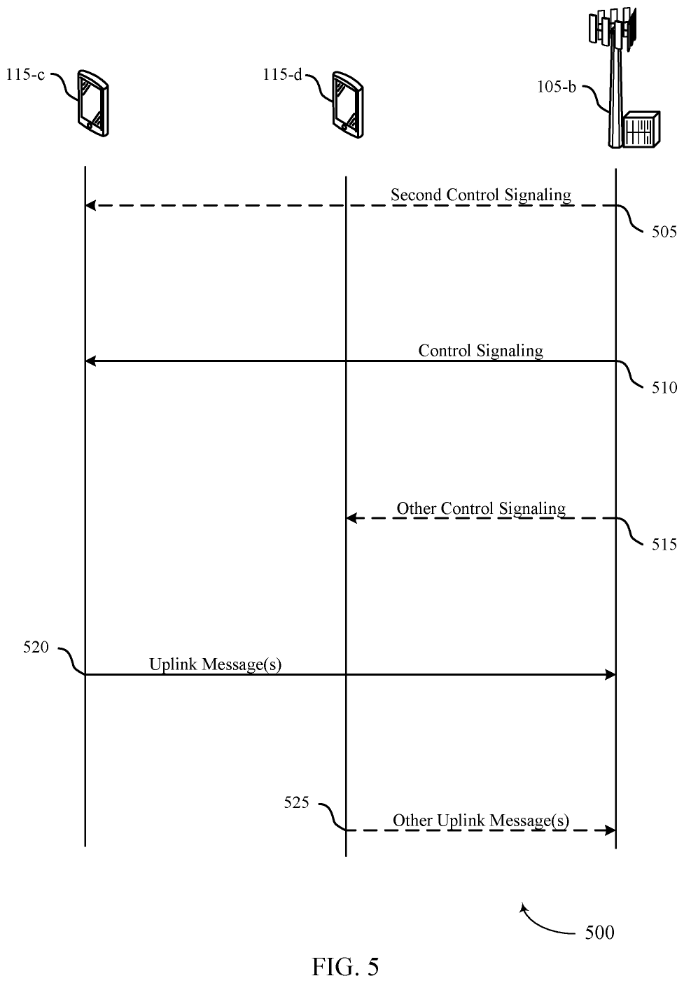

FIG. 5 shows an example of a process flow 500 that supports uplink transmission with OCCs in accordance with one or more aspects of the present disclosure. The process flow 500 includes a UE 115-c, a UE 115-d, and a network entity 105-b, which may be examples of the corresponding devices as described with respect to FIGS. 1 and 2. In the following description of the process flow 500, the operations between the UE 115-c, the UE 115-d, and the network entity 105-b may be performed in a different order than the example order shown. Some operations may also be omitted from the process flow 500, and other operations may be added to the process flow 500. Further, although some operations or signaling may be shown to occur at different times for discussion purposes, these operations may actually occur at the same time. Although some operations are described to be performed by the UE 115-c or the UE 115-d individually, similar operations may also be performed by any of the UE 115-c, the UE 115-d, another UE 115, or a group of UEs 115.

At 505, the UE 115-c optionally may receive, from the network entity 105-b, second control signaling that indicates that an OCC scheme for uplink messages is enabled. To indicate that the OCC scheme is enabled, the second control signaling may indicate one OCC scheme from among a set of OCC schemes. The one indicated OCC scheme may be an example of or may include the OCC scheme that is enabled. The second control signaling may be radio resource control signaling. In some cases, the UE 115-c may receive, from the network entity 105-b, radio resource control signaling that indicates a spreading factor for an OCC.

At 510, the UE 115-c may receive, from the network entity 105-b, control signaling that schedules one or more uplink messages for transmission by the UE 115-c. The control signaling that schedules the one or more uplink messages may also indicate one or more OCC parameters for the one or more uplink messages. The control signaling may be a downlink control information message. In some cases, the control signaling may implicitly indicate that an OCC scheme is enabled based on indicating the one or more OCC parameters.

In some implementations, to indicate the one or more OCC parameters, the control signaling may indicate a row within a TDRA table. The row may correspond to the one or more OCC parameters. The one or more OCC parameters corresponding to the row within the TDRA table may include a spreading factor for the OCC, an OCC index corresponding to the OCC, or both. To indicate the one or more OCC parameters, the control signaling may further indicate that the TDRA table is a first TDRA table from among a set of TDRA tables that comprises the first TDRA table and a second TDRA table. The first TDRA table may include OCC parameters and the second time domain resource allocation table may be devoid of OCC parameters.

In some implementations, to indicate the one or more OCC parameters, the control signaling indicates a row within an OCC table. The row may include the one or more OCC parameters. The UE 115-c may receive, within the control signaling, an indication of a row within a TDRA table. The OCC table may be separate from the TDRA table. The one or more OCC parameters corresponding to the row within the OCC table may include a spreading factor for the OCC, an OCC index corresponding to the OCC, or both.

In some implementations, the control signaling may schedule the one or more uplink messages for transmission by the UE 115-c via a first set of time and frequency resources. At 515, the UE 115-d may receive other control signaling that schedules one or more other uplink messages for transmission by the UE 115-d via a second set of time and frequency resources that at least partially overlaps in time and frequency with the first set of time and frequency resources. The other control signaling that schedules the one or more other uplink messages may also indicate one or more second OCC parameters for the one or more other uplink messages. At least one of the one or more second OCC parameters for the one or more other uplink messages for transmission by the UE 115-d may be different from at least one of the one or more OCC parameters for the one or more uplink messages for transmission by the UE 115-c.

At 520, the UE 115-c may transmit, to the network entity 105-b and based on the control signaling, the one or more uplink messages using the OCC in accordance with the one or more OCC parameters, in accordance with the OCC scheme, or both. Further, transmitting the one or more uplink messages may be in accordance with one or more parameters corresponding to the row within a TDRA table (e.g., the TDRA table, the first TDRA table, the second TDRA table, or any combination thereof).

At 525, the UE 115-d may transmit, to the network entity 105-b and based on the other control signaling, the one or more other uplink messages. The UE 115-d may transmit the one or more other uplink messages based on a second OCC that is different from the OCC and is in accordance with the one or more second OCC parameters.

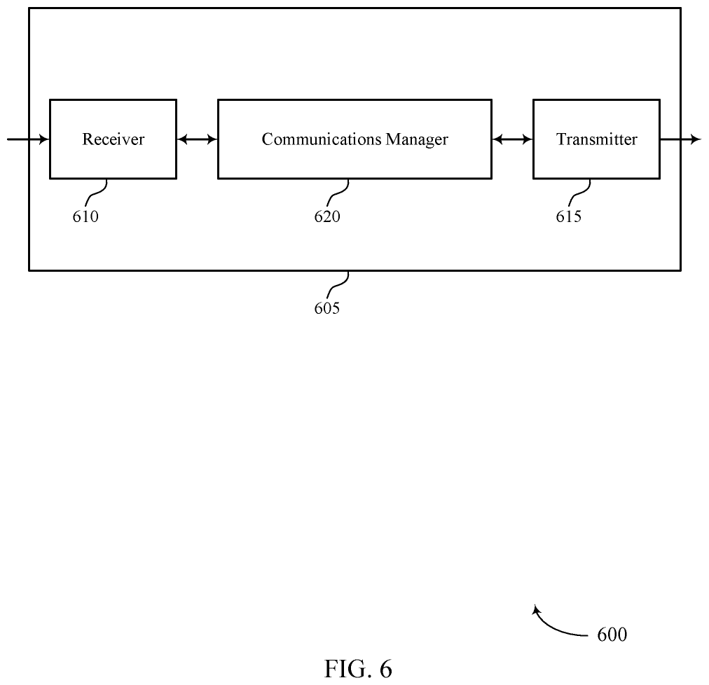

FIG. 6 shows a block diagram 600 of a device 605 that supports uplink transmission with OCCs in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to uplink transmission with OCCs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to uplink transmission with OCCs). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of uplink transmission with OCCs as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving control signaling that schedules one or more uplink messages for transmission by the UE, where the control signaling that schedules the one or more uplink messages also indicates one or more OCC parameters for the one or more uplink messages. The communications manager 620 is capable of, configured to, or operable to support a means for transmitting, based on the control signaling, the one or more uplink messages using an OCC in accordance with the one or more OCC parameters.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for uplink transmission with OCCs, which may result in reduced power consumption, more efficient utilization of communication resources, and transmission with repetition without sacrificing resource efficiency due to repetition, among other advantages.

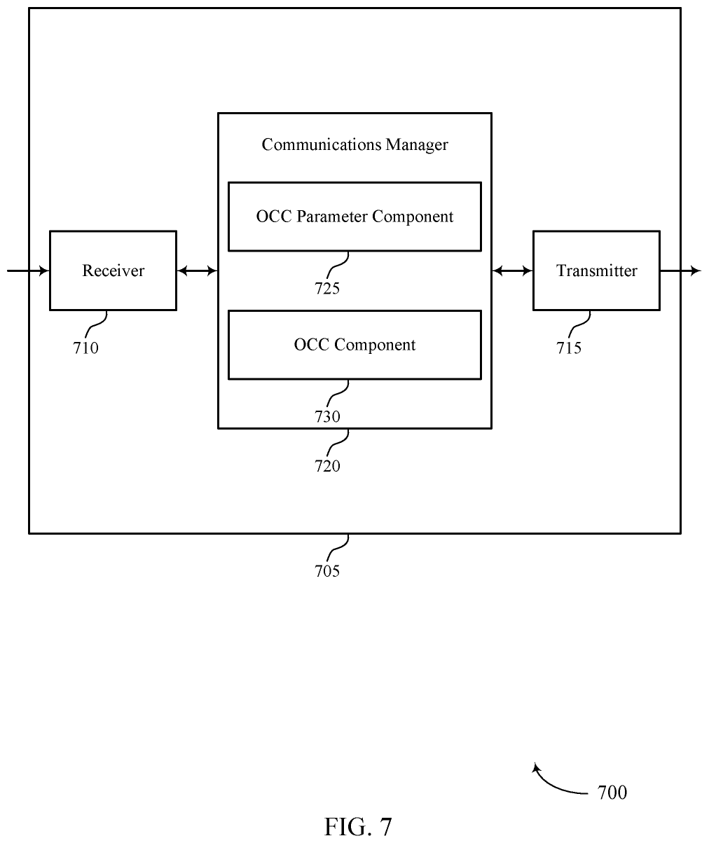

FIG. 7 shows a block diagram 700 of a device 705 that supports uplink transmission with OCCs in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to uplink transmission with OCCs). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to uplink transmission with OCCs). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of uplink transmission with OCCs as described herein. For example, the communications manager 720 may include an OCC parameter component 725 an OCC component 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The OCC parameter component 725 is capable of, configured to, or operable to support a means for receiving control signaling that schedules one or more uplink messages for transmission by the UE, where the control signaling that schedules the one or more uplink messages also indicates one or more OCC parameters for the one or more uplink messages. The OCC component 730 is capable of, configured to, or operable to support a means for transmitting, based on the control signaling, the one or more uplink messages using an OCC in accordance with the one or more OCC parameters.

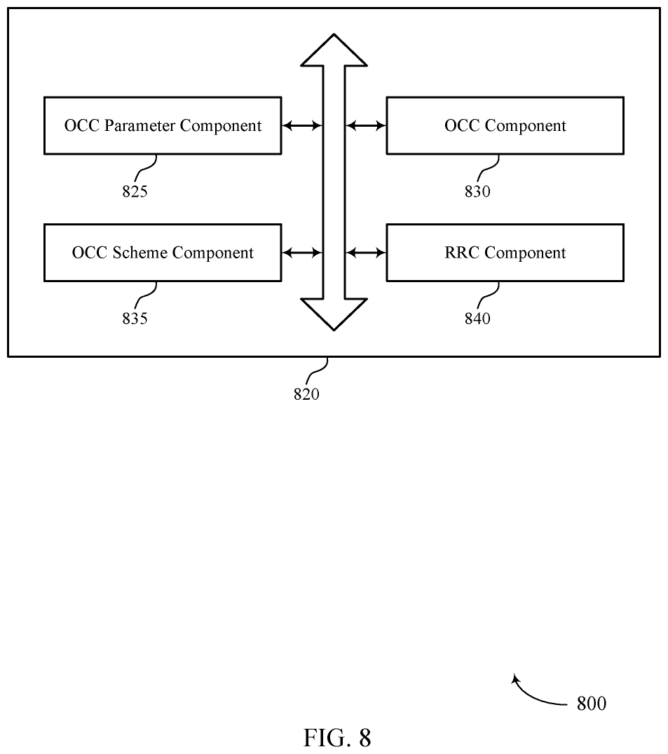

FIG. 8 shows a block diagram 800 of a communications manager 820 that supports uplink transmission with OCCs in accordance with one or more aspects of the present disclosure. The communications manager 820 may be an example of aspects of a communications manager 620, a communications manager 720, or both, as described herein. The communications manager 820, or various components thereof, may be an example of means for performing various aspects of uplink transmission with OCCs as described herein. For example, the communications manager 820 may include an OCC parameter component 825, an OCC component 830, an OCC scheme component 835, an RRC component 840, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The OCC parameter component 825 is capable of, configured to, or operable to support a means for receiving control signaling that schedules one or more uplink messages for transmission by the UE, where the control signaling that schedules the one or more uplink messages also indicates one or more OCC parameters for the one or more uplink messages. The OCC component 830 is capable of, configured to, or operable to support a means for transmitting, based on the control signaling, the one or more uplink messages using an OCC in accordance with the one or more OCC parameters.

In some examples, the OCC scheme component 835 is capable of, configured to, or operable to support a means for receiving second control signaling that indicates that an OCC scheme for uplink messages is enabled, where transmitting the one or more uplink messages is further in accordance with the OCC scheme.

In some examples, to indicate that the OCC scheme is enabled, the second control signaling indicates one OCC scheme from among a set of OCC schemes, the one indicated OCC scheme including the OCC scheme that is enabled.

In some examples, the control signaling includes a downlink control information message. In some examples, the second control signaling includes radio resource control signaling.

In some examples, based on indicating the one or more OCC parameters, the control signaling implicitly indicates that an OCC scheme is enabled.

In some examples, the RRC component 840 is capable of, configured to, or operable to support a means for receiving radio resource control signaling that indicates a spreading factor for the OCC.

In some examples, to indicate the one or more OCC parameters, the control signaling indicates a row within a TDRA table, the row corresponding to the one or more OCC parameters.

In some examples, the one or more OCC parameters corresponding to the row within the TDRA table include a spreading factor for the OCC, an OCC index corresponding to the OCC, or both.

In some examples, to indicate the one or more OCC parameters, the control signaling further indicates that the TDRA table is a first TDRA table from among a set of TDRA tables that includes the first TDRA table and a second TDRA table, the first TDRA table including OCC parameters and the second TDRA table devoid of OCC parameters.

In some examples, to indicate the one or more OCC parameters, the control signaling indicates a row within an OCC table, the row including the one or more OCC parameters.

In some examples, the OCC parameter component 825 is capable of, configured to, or operable to support a means for receiving, within the control signaling, an indication of a row within a TDRA table, where transmitting the one or more uplink messages is further in accordance with one or more parameters corresponding to the row within the TDRA table, and where the OCC table is separate from the TDRA table.

In some examples, the one or more OCC parameters corresponding to the row within the OCC table include a spreading factor for the OCC, an OCC index corresponding to the OCC, or both.

In some examples, to support transmitting the one or more uplink messages, the OCC component 830 is capable of, configured to, or operable to support a means for transmitting the one or more uplink messages via a physical uplink shared channel.

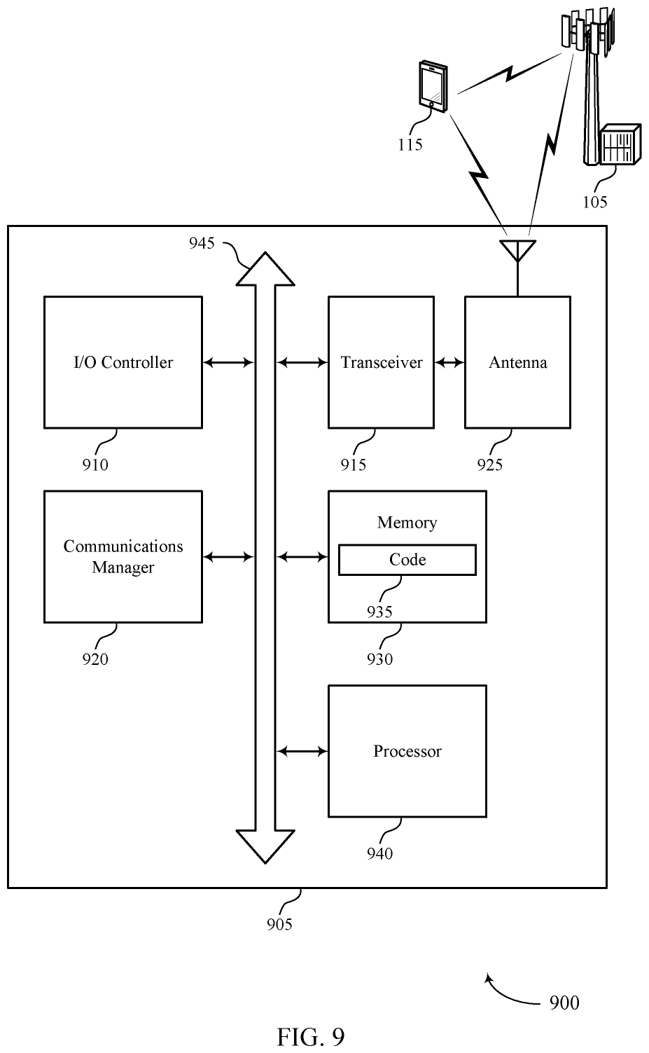

FIG. 9 shows a diagram of a system 900 including a device 905 that supports uplink transmission with OCCs in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting uplink transmission with OCCs). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving control signaling that schedules one or more uplink messages for transmission by the UE, where the control signaling that schedules the one or more uplink messages also indicates one or more OCC parameters for the one or more uplink messages. The communications manager 920 is capable of, configured to, or operable to support a means for transmitting, based on the control signaling, the one or more uplink messages using an OCC in accordance with the one or more OCC parameters.

By including or configuring the communications manager 920 in accordance with examples as described herein, the device 905 may support techniques for uplink transmission with OCCs, which may result in reduced power consumption, improved coordination between devices, longer battery life, improved utilization of processing capability, more efficient utilization of communication resources, and transmission with repetition without sacrificing resource efficiency due to repetition, among other advantages.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of uplink transmission with OCCs as described herein, or the at least one processor 940 and the at least one memory 930 may be otherwise configured to, individually or collectively, perform or support such operations.

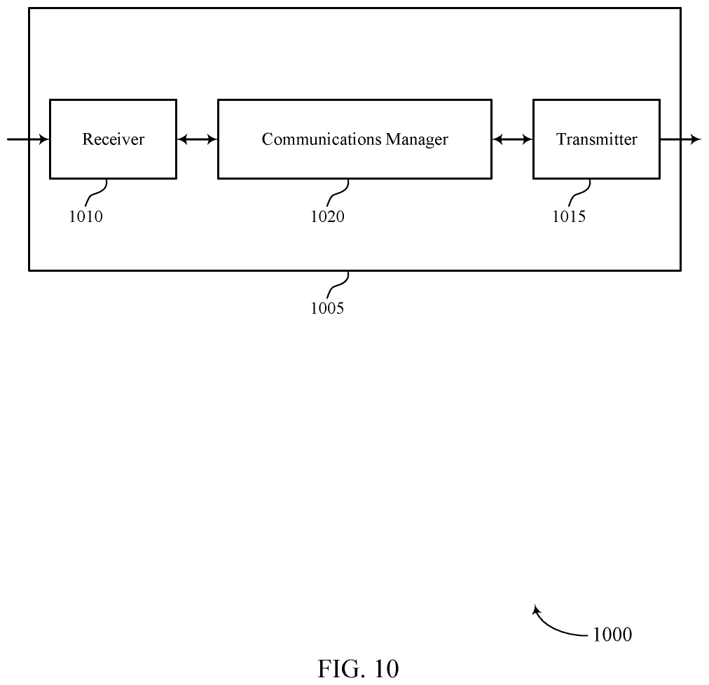

FIG. 10 shows a block diagram 1000 of a device 1005 that supports uplink transmission with OCCs in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of uplink transmission with OCCs as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for outputting control signaling that schedules one or more uplink messages for transmission by a UE, where the control signaling that schedules the one or more uplink messages also indicates one or more OCC parameters for the one or more uplink messages. The communications manager 1020 is capable of, configured to, or operable to support a means for obtaining, based on the control signaling, the one or more uplink messages based on an OCC that is in accordance with the one or more OCC parameters.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for uplink transmission with OCCs, which may result in reduced power consumption, more efficient utilization of communication resources, and transmission with repetition without sacrificing resource efficiency due to repetition, among other advantages.

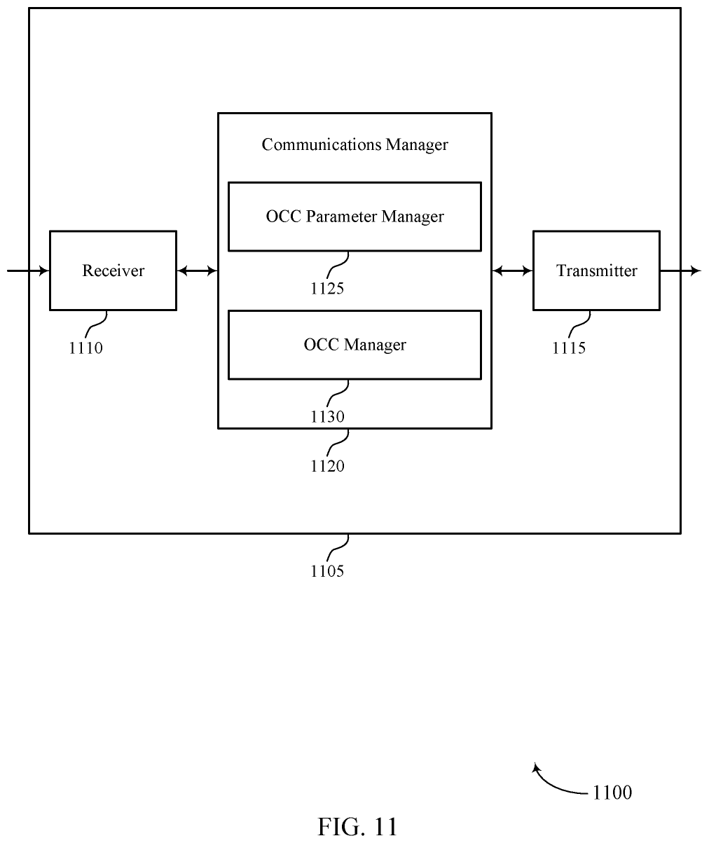

FIG. 11 shows a block diagram 1100 of a device 1105 that supports uplink transmission with OCCs in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of uplink transmission with OCCs as described herein. For example, the communications manager 1120 may include an OCC parameter manager 1125 an OCC manager 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The OCC parameter manager 1125 is capable of, configured to, or operable to support a means for outputting control signaling that schedules one or more uplink messages for transmission by a UE, where the control signaling that schedules the one or more uplink messages also indicates one or more OCC parameters for the one or more uplink messages. The OCC manager 1130 is capable of, configured to, or operable to support a means for obtaining, based on the control signaling, the one or more uplink messages based on an OCC that is in accordance with the one or more OCC parameters.

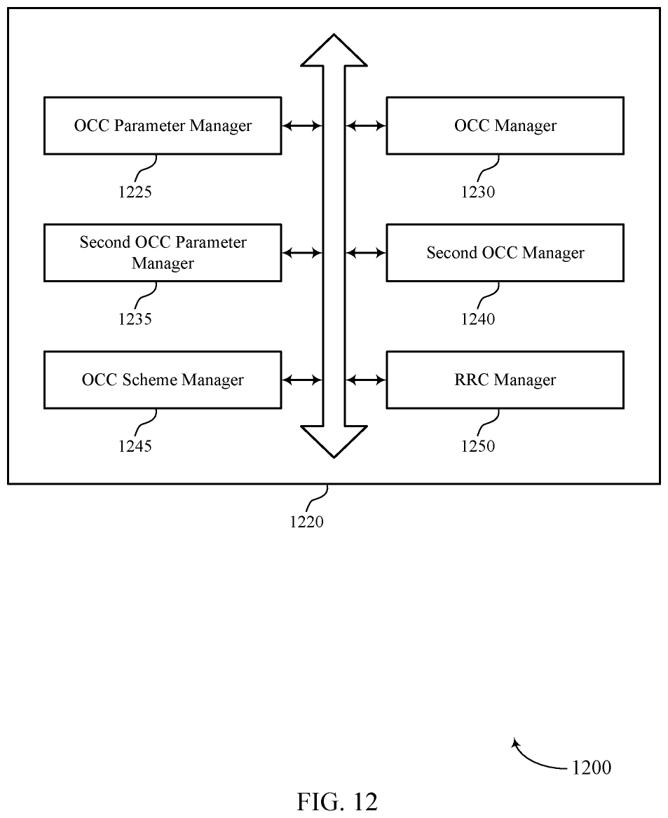

FIG. 12 shows a block diagram 1200 of a communications manager 1220 that supports uplink transmission with OCCs in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of uplink transmission with OCCs as described herein. For example, the communications manager 1220 may include an OCC parameter manager 1225, an OCC manager 1230, a second OCC parameter manager 1235, a second OCC manager 1240, an OCC scheme manager 1245, an RRC manager 1250, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The OCC parameter manager 1225 is capable of, configured to, or operable to support a means for outputting control signaling that schedules one or more uplink messages for transmission by a UE, where the control signaling that schedules the one or more uplink messages also indicates one or more OCC parameters for the one or more uplink messages. The OCC manager 1230 is capable of, configured to, or operable to support a means for obtaining, based on the control signaling, the one or more uplink messages based on an OCC that is in accordance with the one or more OCC parameters.

In some examples, the control signaling schedules the one or more uplink messages for transmission by the UE via a first set of time and frequency resources, and the second OCC parameter manager 1235 is capable of, configured to, or operable to support a means for outputting other control signaling that schedules one or more other uplink messages for transmission by a second UE via a second set of time and frequency resources that at least partially overlaps in time and frequency with the first set of time and frequency resources, where the other control signaling that schedules the one or more other uplink messages also indicates one or more second OCC parameters for the one or more other uplink messages, and where at least one of the one or more second OCC parameters for the one or more other uplink messages for transmission by the second UE is different from at least one of the one or more OCC parameters for the one or more uplink messages for transmission by the UE. In some examples, the control signaling schedules the one or more uplink messages for transmission by the UE via a first set of time and frequency resources, and the second OCC manager 1240 is capable of, configured to, or operable to support a means for obtaining, based on the other control signaling, the one or more other uplink messages based on a second OCC that is different from the OCC and is in accordance with the one or more second OCC parameters.

In some examples, the OCC scheme manager 1245 is capable of, configured to, or operable to support a means for outputting second control signaling that indicates that an OCC scheme for uplink messages is enabled, where the one or more uplink messages are further in accordance with the OCC scheme.

In some examples, to indicate that the OCC scheme is enabled, the second control signaling indicates one OCC scheme from among a set of OCC schemes, the one indicated OCC scheme including the OCC scheme that is enabled.

In some examples, the control signaling includes a downlink control information message. In some examples, the second control signaling includes radio resource control signaling.

In some examples, based on indicating the one or more OCC parameters, the control signaling implicitly indicates that an OCC scheme is enabled.

In some examples, the RRC manager 1250 is capable of, configured to, or operable to support a means for outputting radio resource control signaling that indicates a spreading factor for the OCC.

In some examples, to indicate the one or more OCC parameters, the control signaling indicates a row within a TDRA table, the row corresponding to the one or more OCC parameters.

In some examples, the one or more OCC parameters corresponding to the row within the TDRA table include a spreading factor for the OCC, an OCC index corresponding to the OCC, or both.

In some examples, to indicate the one or more OCC parameters, the control signaling further indicates that the TDRA table is a first TDRA table from among a set of TDRA tables that includes the first TDRA table and a second TDRA table, the first TDRA table including OCC parameters and the second TDRA table devoid of OCC parameters.

In some examples, to indicate the one or more OCC parameters, the control signaling indicates a row within an OCC table, the row including the one or more OCC parameters.

In some examples, the OCC parameter manager 1225 is capable of, configured to, or operable to support a means for outputting, within the control signaling, an indication of a row within a TDRA table, where obtaining the one or more uplink messages is further in accordance with one or more parameters corresponding to the row within the TDRA table, and where the OCC table is separate from the TDRA table.

In some examples, the one or more OCC parameters corresponding to the row within the OCC table include a spreading factor for the OCC, an OCC index corresponding to the OCC, or both.

In some examples, to support obtaining the one or more uplink messages, the OCC manager 1230 is capable of, configured to, or operable to support a means for obtaining the one or more uplink messages via a physical uplink shared channel.

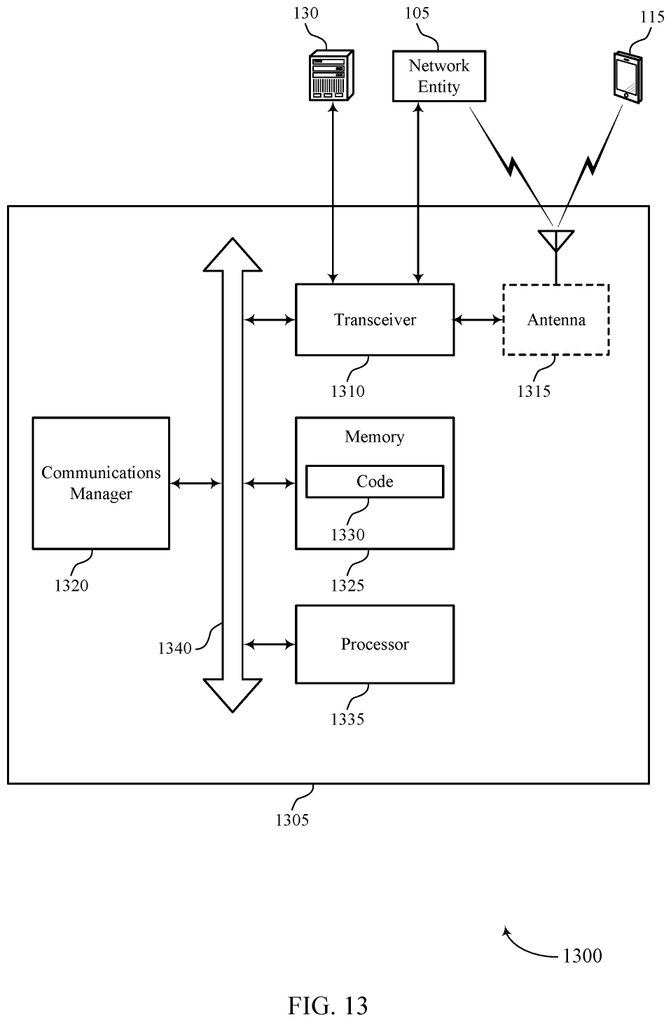

FIG. 13 shows a diagram of a system 1300 including a device 1305 that supports uplink transmission with OCCs in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting uplink transmission with OCCs). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for outputting control signaling that schedules one or more uplink messages for transmission by a UE, where the control signaling that schedules the one or more uplink messages also indicates one or more OCC parameters for the one or more uplink messages. The communications manager 1320 is capable of, configured to, or operable to support a means for obtaining, based on the control signaling, the one or more uplink messages based on an OCC that is in accordance with the one or more OCC parameters.

By including or configuring the communications manager 1320 in accordance with examples as described herein, the device 1305 may support techniques for uplink transmission with OCCs, which may result in reduced power consumption, improved coordination between devices, longer battery life, improved utilization of processing capability, more efficient utilization of communication resources, and transmission with repetition without sacrificing resource efficiency due to repetition, among other advantages.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of uplink transmission with OCCs as described herein, or the at least one processor 1335 and the at least one memory 1325 may be otherwise configured to, individually or collectively, perform or support such operations.

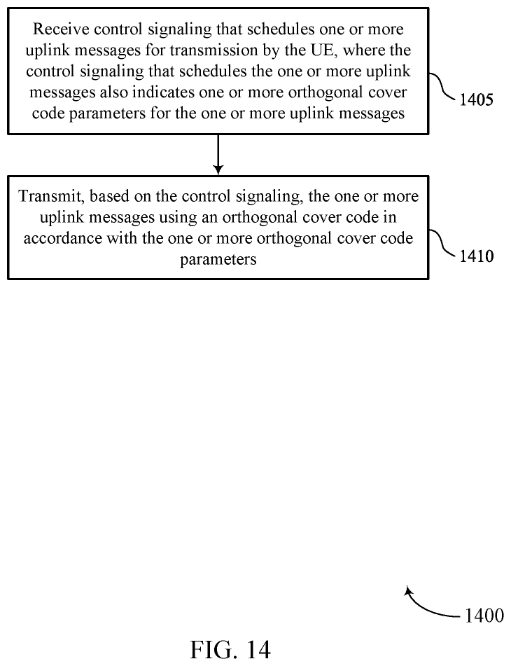

FIG. 14 shows a flowchart illustrating a method 1400 that supports uplink transmission with OCCs in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving control signaling that schedules one or more uplink messages for transmission by the UE, where the control signaling that schedules the one or more uplink messages also indicates one or more OCC parameters for the one or more uplink messages. The operations of 1405 may be performed in accordance with examples as disclosed herein. In some examples, aspects of the operations of 1405 may be performed by an OCC parameter component 825 as described with reference to FIG. 8.

At 1410, the method may include transmitting, based on the control signaling, the one or more uplink messages using an OCC in accordance with the one or more OCC parameters. The operations of 1410 may be performed in accordance with examples as disclosed herein. In some examples, aspects of the operations of 1410 may be performed by an OCC component 830 as described with reference to FIG. 8.

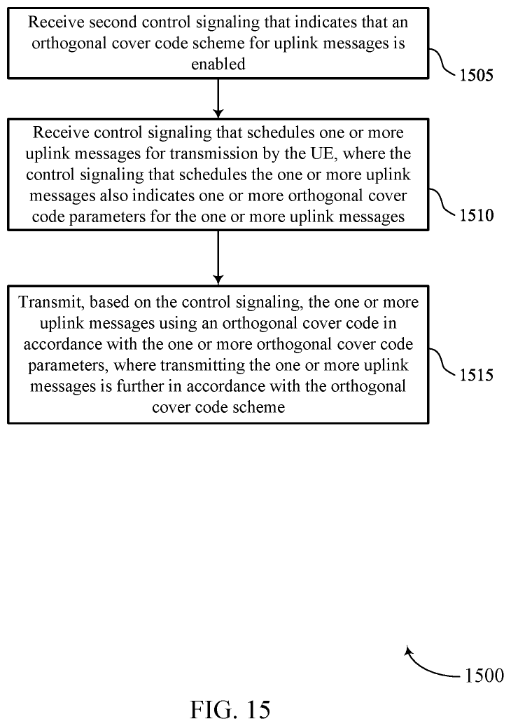

FIG. 15 shows a flowchart illustrating a method 1500 that supports uplink transmission with OCCs in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving second control signaling that indicates that an OCC scheme for uplink messages is enabled. The operations of 1505 may be performed in accordance with examples as disclosed herein. In some examples, aspects of the operations of 1505 may be performed by an OCC scheme component 835 as described with reference to FIG. 8.

At 1510, the method may include receiving control signaling that schedules one or more uplink messages for transmission by the UE, where the control signaling that schedules the one or more uplink messages also indicates one or more OCC parameters for the one or more uplink messages. The operations of 1510 may be performed in accordance with examples as disclosed herein. In some examples, aspects of the operations of 1510 may be performed by an OCC parameter component 825 as described with reference to FIG. 8.

At 1515, the method may include transmitting, based on the control signaling, the one or more uplink messages using an OCC in accordance with the one or more OCC parameters, where transmitting the one or more uplink messages is further in accordance with the OCC scheme. The operations of 1515 may be performed in accordance with examples as disclosed herein. In some examples, aspects of the operations of 1515 may be performed by an OCC component 830 as described with reference to FIG. 8.

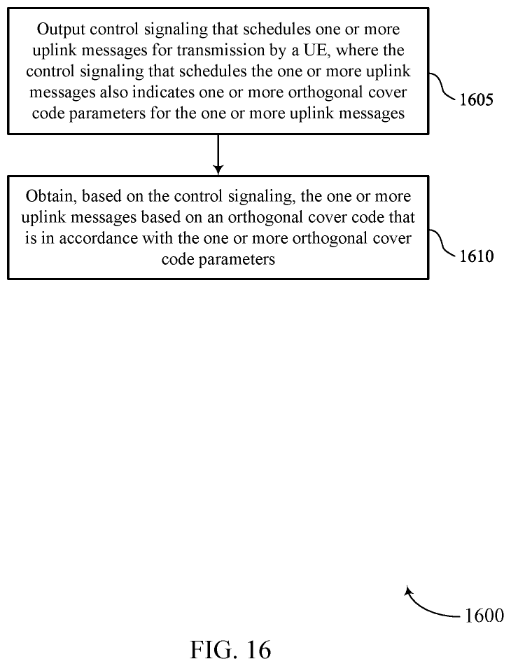

FIG. 16 shows a flowchart illustrating a method 1600 that supports uplink transmission with OCCs in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include outputting control signaling that schedules one or more uplink messages for transmission by a UE, where the control signaling that schedules the one or more uplink messages also indicates one or more OCC parameters for the one or more uplink messages. The operations of 1605 may be performed in accordance with examples as disclosed herein. In some examples, aspects of the operations of 1605 may be performed by an OCC parameter manager 1225 as described with reference to FIG. 12.

At 1610, the method may include obtaining, based on the control signaling, the one or more uplink messages based on an OCC that is in accordance with the one or more OCC parameters. The operations of 1610 may be performed in accordance with examples as disclosed herein. In some examples, aspects of the operations of 1610 may be performed by an OCC manager 1230 as described with reference to FIG. 12.

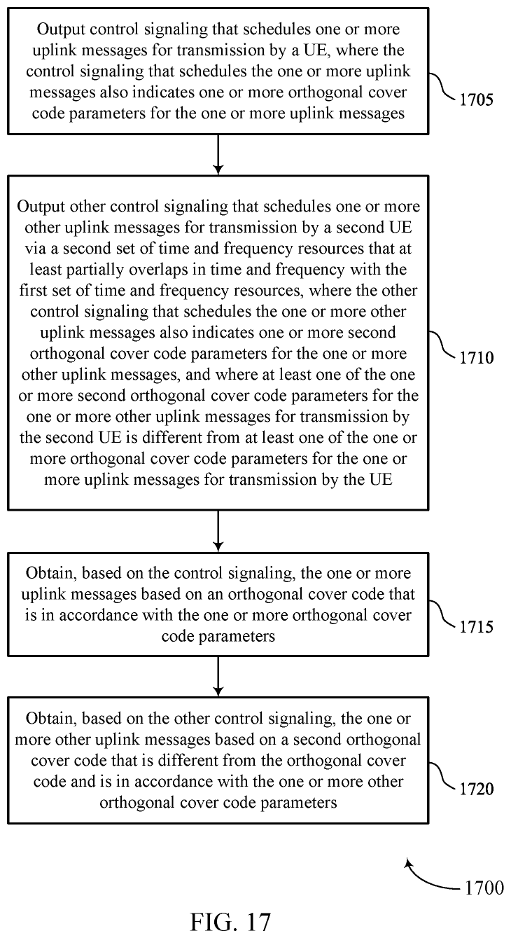

FIG. 17 shows a flowchart illustrating a method 1700 that supports uplink transmission with OCCs in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include outputting control signaling that schedules one or more uplink messages for transmission by a UE, where the control signaling that schedules the one or more uplink messages also indicates one or more OCC parameters for the one or more uplink messages. The operations of 1705 may be performed in accordance with examples as disclosed herein. In some examples, aspects of the operations of 1705 may be performed by an OCC parameter manager 1225 as described with reference to FIG. 12.

At 1710, the method may include outputting other control signaling that schedules one or more other uplink messages for transmission by a second UE via a second set of time and frequency resources that at least partially overlaps in time and frequency with the first set of time and frequency resources, where the other control signaling that schedules the one or more other uplink messages also indicates one or more second OCC parameters for the one or more other uplink messages, and where at least one of the one or more second OCC parameters for the one or more other uplink messages for transmission by the second UE is different from at least one of the one or more OCC parameters for the one or more uplink messages for transmission by the UE. The operations of 1710 may be performed in accordance with examples as disclosed herein. In some examples, aspects of the operations of 1710 may be performed by a second OCC parameter manager 1235 as described with reference to FIG. 12.

At 1715, the method may include obtaining, based on the control signaling, the one or more uplink messages based on an OCC that is in accordance with the one or more OCC parameters. The operations of 1715 may be performed in accordance with examples as disclosed herein. In some examples, aspects of the operations of 1710 may be performed by an OCC manager 1230 as described with reference to FIG. 12.

At 1720, the method may include obtaining, based on the other control signaling, the one or more other uplink messages based on a second OCC that is different from the OCC and is in accordance with the one or more second OCC parameters. For example, the one or more other uplink messages may be obtained from the second UE via resources that partially or wholly overlap in time, in frequency, or both with resources via which the one or more uplink messages are obtained from the UE. The operations of 1720 may be performed in accordance with examples as disclosed herein. In some examples, aspects of the operations of 1720 may be performed by a second OCC manager 1240 as described with reference to FIG. 12.

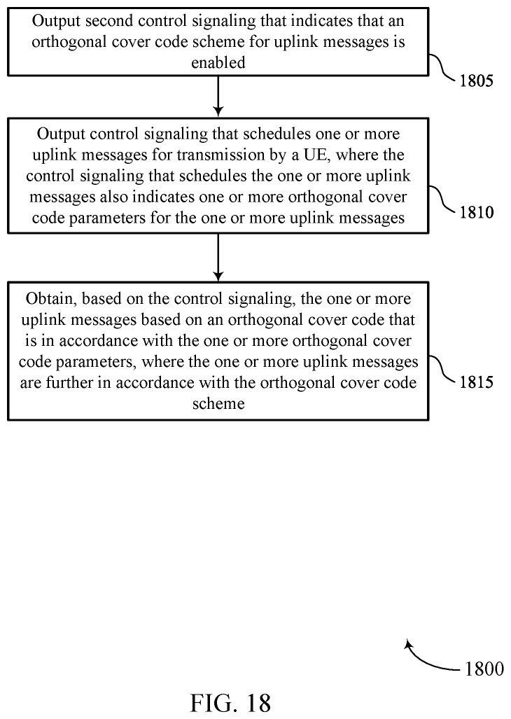

FIG. 18 shows a flowchart illustrating a method 1800 that supports uplink transmission with OCCs in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include outputting second control signaling that indicates that an OCC scheme for uplink messages is enabled. The operations of 1805 may be performed in accordance with examples as disclosed herein. In some examples, aspects of the operations of 1805 may be performed by an OCC scheme manager 1245 as described with reference to FIG. 12.

At 1810, the method may include outputting control signaling that schedules one or more uplink messages for transmission by a UE, where the control signaling that schedules the one or more uplink messages also indicates one or more OCC parameters for the one or more uplink messages. The operations of 1810 may be performed in accordance with examples as disclosed herein. In some examples, aspects of the operations of 1810 may be performed by an OCC parameter manager 1225 as described with reference to FIG. 12.

At 1815, the method may include obtaining, based on the control signaling, the one or more uplink messages based on an OCC that is in accordance with the one or more OCC parameters, where the one or more uplink messages are further in accordance with the OCC scheme. The operations of 1815 may be performed in accordance with examples as disclosed herein. In some examples, aspects of the operations of 1815 may be performed by an OCC manager 1230 as described with reference to FIG. 12.

The following provides an overview of aspects of the present disclosure:

Aspect 1: A method for wireless communications at a UE, comprising: receiving control signaling that schedules one or more uplink messages for transmission by the UE, wherein the control signaling that schedules the one or more uplink messages also indicates one or more OCC parameters for the one or more uplink messages; and transmitting, based at least in part on the control signaling, the one or more uplink messages using an OCC in accordance with the one or more OCC parameters.

Aspect 2: The method of aspect 1, further comprising: receiving second control signaling that indicates that an OCC scheme for uplink messages is enabled, wherein transmitting the one or more uplink messages is further in accordance with the OCC scheme.

Aspect 3: The method of aspect 2, wherein to indicate that the OCC scheme is enabled, the second control signaling indicates one OCC scheme from among a set of OCC schemes, the one indicated OCC scheme comprising the OCC scheme that is enabled.

Aspect 4: The method of any of aspects 2 through 3, wherein the control signaling comprises a downlink control information message, and the second control signaling comprises radio resource control signaling.

Aspect 5: The method of any of aspects 1 through 4, wherein based at least in part on indicating the one or more OCC parameters, the control signaling implicitly indicates that an OCC scheme is enabled.

Aspect 6: The method of any of aspects 1 through 5, further comprising: receiving radio resource control signaling that indicates a spreading factor for the OCC.

Aspect 7: The method of any of aspects 1 through 6, wherein to indicate the one or more OCC parameters, the control signaling indicates a row within a TDRA table, the row corresponding to the one or more OCC parameters.

Aspect 8: The method of aspect 7, wherein the one or more OCC parameters corresponding to the row within the TDRA table comprise a spreading factor for the OCC, an OCC index corresponding to the OCC, or both.

Aspect 9: The method of any of aspects 7 through 8, wherein to indicate the one or more OCC parameters, the control signaling further indicates that the TDRA table is a first TDRA table from among a set of TDRA tables that comprises the first TDRA table and a second TDRA table, the first TDRA table comprising OCC parameters and the second TDRA table devoid of OCC parameters.

Aspect 10: The method of any of aspects 1 through 9, wherein to indicate the one or more OCC parameters, the control signaling indicates a row within an OCC table, the row comprising the one or more OCC parameters.

Aspect 11: The method of aspect 10, further comprising: receiving, within the control signaling, an indication of a row within a TDRA table, wherein transmitting the one or more uplink messages is further in accordance with one or more parameters corresponding to the row within the TDRA table, and wherein the OCC table is separate from the TDRA table.

Aspect 12: The method of any of aspects 10 through 11, wherein the one or more OCC parameters corresponding to the row within the OCC table comprise a spreading factor for the OCC, an OCC index corresponding to the OCC, or both.

Aspect 13: The method of any of aspects 1 through 12, wherein transmitting the one or more uplink messages comprises: transmitting the one or more uplink messages via a PUSCH.

Aspect 14: A method for wireless communications at a network entity, comprising: outputting control signaling that schedules one or more uplink messages for transmission by a UE, wherein the control signaling that schedules the one or more uplink messages also indicates one or more OCC parameters for the one or more uplink messages; and obtaining, based at least in part on the control signaling, the one or more uplink messages based at least in part on an OCC that is in accordance with the one or more OCC parameters.

Aspect 15: The method of aspect 14, wherein the control signaling schedules the one or more uplink messages for transmission by the UE via a first set of time and frequency resources, the method further comprising: outputting other control signaling that schedules one or more other uplink messages for transmission by a second UE via a second set of time and frequency resources that at least partially overlaps in time and frequency with the first set of time and frequency resources, wherein the other control signaling that schedules the one or more other uplink messages also indicates one or more second OCC parameters for the one or more other uplink messages, and wherein at least one of the one or more second OCC parameters for the one or more other uplink messages for transmission by the second UE is different from at least one of the one or more OCC parameters for the one or more uplink messages for transmission by the UE; and obtaining, based at least in part on the other control signaling, the one or more other uplink messages based at least in part on a second OCC that is different from the OCC and is in accordance with the one or more second OCC parameters.

Aspect 16: The method of any of aspects 14 through 15, further comprising: outputting second control signaling that indicates that an OCC scheme for uplink messages is enabled, wherein the one or more uplink messages are further in accordance with the OCC scheme.

Aspect 17: The method of aspect 16, wherein to indicate that the OCC scheme is enabled, the second control signaling indicates one OCC scheme from among a set of OCC schemes, the one indicated OCC scheme comprising the OCC scheme that is enabled.

Aspect 18: The method of any of aspects 16 through 17, wherein the control signaling comprises a downlink control information message, and the second control signaling comprises radio resource control signaling.

Aspect 19: The method of any of aspects 14 through 18, wherein based at least in part on indicating the one or more OCC parameters, the control signaling implicitly indicates that an OCC scheme is enabled.

Aspect 20: The method of any of aspects 14 through 19, further comprising: outputting radio resource control signaling that indicates a spreading factor for the OCC.

Aspect 21: The method of any of aspects 14 through 20, wherein to indicate the one or more OCC parameters, the control signaling indicates a row within a TDRA table, the row corresponding to the one or more OCC parameters.

Aspect 22: The method of aspect 21, wherein the one or more OCC parameters corresponding to the row within the TDRA table comprise a spreading factor for the OCC, an OCC index corresponding to the OCC, or both.

Aspect 23: The method of any of aspects 21 through 22, wherein to indicate the one or more OCC parameters, the control signaling further indicates that the TDRA table is a first TDRA table from among a set of TDRA tables that comprises the first TDRA table and a second TDRA table, the first TDRA table comprising OCC parameters and the second TDRA table devoid of OCC parameters.

Aspect 24: The method of any of aspects 14 through 23, wherein to indicate the one or more OCC parameters, the control signaling indicates a row within an OCC table, the row comprising the one or more OCC parameters.

Aspect 25: The method of aspect 24, further comprising: outputting, within the control signaling, an indication of a row within a TDRA table, wherein obtaining the one or more uplink messages is further in accordance with one or more parameters corresponding to the row within the TDRA table, and wherein the OCC table is separate from the TDRA table.

Aspect 26: The method of any of aspects 24 through 25, wherein the one or more OCC parameters corresponding to the row within the OCC table comprise a spreading factor for the OCC, an OCC index corresponding to the OCC, or both.

Aspect 27: The method of any of aspects 14 through 26, wherein obtaining the one or more uplink messages comprises: obtaining the one or more uplink messages via a PUSCH.

Aspect 28: A UE for wireless communications, comprising one or more memories storing processor-executable code, and one or more processors coupled with the one or more memories and individually or collectively operable to execute the code to cause the UE to perform a method of any of aspects 1 through 13.

Aspect 29: A UE for wireless communications, comprising at least one means for performing a method of any of aspects 1 through 13.

Aspect 30: A non-transitory computer-readable medium storing code for wireless communications, the code comprising instructions executable by one or more processors to perform a method of any of aspects 1 through 13.

Aspect 31: A network entity for wireless communications, comprising one or more memories storing processor-executable code, and one or more processors coupled with the one or more memories and individually or collectively operable to execute the code to cause the network entity to perform a method of any of aspects 14 through 27.

Aspect 32: A network entity for wireless communications, comprising at least one means for performing a method of any of aspects 14 through 27.

Aspect 33: A non-transitory computer-readable medium storing code for wireless communications, the code comprising instructions executable by one or more processors to perform a method of any of aspects 14 through 27.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling that schedules one or more uplink messages for transmission by the UE, wherein the control signaling that schedules the one or more uplink messages also indicates one or more orthogonal cover code parameters for the one or more uplink messages; and
transmit, based at least in part on the control signaling, the one or more uplink messages using an orthogonal cover code in accordance with the one or more orthogonal cover code parameters.

2. The UE of claim 1, wherein the one or more processors are individually or collectively further operable to execute the code to cause the UE to:
receive second control signaling that indicates that an orthogonal cover code scheme for uplink messages is enabled, wherein transmitting the one or more uplink messages is further in accordance with the orthogonal cover code scheme.

3. The UE of claim 2, wherein, to indicate that the orthogonal cover code scheme is enabled, the second control signaling indicates one orthogonal cover code scheme from among a set of orthogonal cover code schemes, the one indicated orthogonal cover code scheme comprising the orthogonal cover code scheme that is enabled.

4. The UE of claim 2, wherein:
the control signaling comprises a downlink control information message, and
the second control signaling comprises radio resource control signaling.

5. The UE of claim 1, wherein, based at least in part on indicating the one or more orthogonal cover code parameters, the control signaling implicitly indicates that an orthogonal cover code scheme is enabled.

6. The UE of claim 1, wherein the one or more processors are individually or collectively further operable to execute the code to cause the UE to:
receive radio resource control signaling that indicates a spreading factor for the orthogonal cover code.

7. The UE of claim 1, wherein, to indicate the one or more orthogonal cover code parameters, the control signaling indicates a row within a time domain resource allocation table, the row corresponding to the one or more orthogonal cover code parameters.

8. The UE of claim 7, wherein the one or more orthogonal cover code parameters corresponding to the row within the time domain resource allocation table comprise a spreading factor for the orthogonal cover code, an orthogonal cover code index corresponding to the orthogonal cover code, or both.

9. The UE of claim 7, wherein, to indicate the one or more orthogonal cover code parameters, the control signaling further indicates that the time domain resource allocation table is a first time domain resource allocation table from among a set of time domain resource allocation tables that comprises the first time domain resource allocation table and a second time domain resource allocation table, the first time domain resource allocation table comprising orthogonal cover code parameters and the second time domain resource allocation table devoid of orthogonal cover code parameters.

10. The UE of claim 1, wherein, to indicate the one or more orthogonal cover code parameters, the control signaling indicates a row within an orthogonal cover code table, the row comprising the one or more orthogonal cover code parameters.

11. The UE of claim 10, wherein the one or more processors are individually or collectively further operable to execute the code to cause the UE to:
receive, within the control signaling, an indication of a row within a time domain resource allocation table, wherein the one or more processors are individually or collectively operable to execute the code to cause the UE to transmit the one or more uplink messages further in accordance with one or more parameters corresponding to the row within the time domain resource allocation table, and wherein the orthogonal cover code table is separate from the time domain resource allocation table.

12. The UE of claim 10, wherein the one or more orthogonal cover code parameters corresponding to the row within the orthogonal cover code table comprise a spreading factor for the orthogonal cover code, an orthogonal cover code index corresponding to the orthogonal cover code, or both.

13. The UE of claim 1, wherein, to transmit the one or more uplink messages, the one or more processors are individually or collectively operable to execute the code to cause the UE to:
transmit the one or more uplink messages via a physical uplink shared channel.

14. A network entity, comprising:
one or more memories storing processor-executable code; and
one or more processors coupled with the one or more memories and individually or collectively operable to execute the code to cause the network entity to:
output control signaling that schedules one or more uplink messages for transmission by a user equipment (UE), wherein the control signaling that schedules the one or more uplink messages also indicates one or more orthogonal cover code parameters for the one or more uplink messages; and
obtain, based at least in part on the control signaling, the one or more uplink messages based at least in part on an orthogonal cover code that is in accordance with the one or more orthogonal cover code parameters.

15. The network entity of claim 14, wherein the control signaling schedules the one or more uplink messages for transmission by the UE via a first set of time and frequency resources, and wherein the one or more processors are individually or collectively further operable to execute the code to cause the network entity to:
output other control signaling that schedules one or more other uplink messages for transmission by a second UE via a second set of time and frequency resources that at least partially overlaps in time and frequency with the first set of time and frequency resources, wherein the other control signaling that schedules the one or more other uplink messages also indicates one or more second orthogonal cover code parameters for the one or more other uplink messages, and wherein at least one of the one or more second orthogonal cover code parameters for the one or more other uplink messages for transmission by the second UE is different from at least one of the one or more orthogonal cover code parameters for the one or more uplink messages for transmission by the UE; and
obtain, based at least in part on the other control signaling, the one or more other uplink messages based at least in part on a second orthogonal cover code that is different from the orthogonal cover code and is in accordance with the one or more second orthogonal cover code parameters.

16. The network entity of claim 14, wherein the one or more processors are individually or collectively further operable to execute the code to cause the network entity to:
output second control signaling that indicates that an orthogonal cover code scheme for uplink messages is enabled, wherein the one or more uplink messages are further in accordance with the orthogonal cover code scheme.

17. The network entity of claim 14, wherein, to indicate the one or more orthogonal cover code parameters, the control signaling indicates a row within a time domain resource allocation table, the row corresponding to the one or more orthogonal cover code parameters.

18. The network entity of claim 17, wherein, to indicate the one or more orthogonal cover code parameters, the control signaling further indicates that the time domain resource allocation table is a first time domain resource allocation table from among a set of time domain resource allocation tables that comprises the first time domain resource allocation table and a second time domain resource allocation table, the first time domain resource allocation table comprising orthogonal cover code parameters and the second time domain resource allocation table devoid of orthogonal cover code parameters.

19. The network entity of claim 14, wherein, to indicate the one or more orthogonal cover code parameters, the control signaling indicates a row within an orthogonal cover code table, the row comprising the one or more orthogonal cover code parameters.

20. A method for wireless communications at a user equipment (UE), comprising:
receiving control signaling that schedules one or more uplink messages for transmission by the UE, wherein the control signaling that schedules the one or more uplink messages also indicates one or more orthogonal cover code parameters for the one or more uplink messages; and
transmitting, based at least in part on the control signaling, the one or more uplink messages using an orthogonal cover code in accordance with the one or more orthogonal cover code parameters.
